(19) United States
(12) Patent Application Publication
(10) Pub. No.: US 2026/0119912 A1
(43) Pub. Date: Apr. 30, 2026

(54) KNOWLEDGE FABRIC WITH MECHANISTIC CAUSAL REASONING AND DEEP LANGUAGE UNDERSTANDING

(71) Applicant: EMPATHI AI INC., Joplin, MO (US)

(72) Inventor: Joseph C. Roushar, Joplin, MO (US)

(21) Appl. No.: 19/214,139

(22) Filed: May 21, 2025

Related U.S. Application Data
(60) Provisional application No. 63/714,627, filed on Oct. 31, 2024.

(51) Int. Cl. G06N 5/022; G06F 40/284; G06F 40/289; G06F 40/30

(52) U.S. Cl. CPC G06N 5/022; G06F 40/284; G06F 40/289; G06F 40/30

(57) ABSTRACT

System and method for using knowledge fabric based on knowledge ontology, designed for deep language understanding and mechanistic causal reasoning, and meta-knowledge repository for auditable question answering. The method includes receiving an input text from a user, building a knowledge graph that represents real world facts and associations in the form of contextually tagged and weighted knowledge propositions, in multiple knowledge domains. The knowledge graph in combination with causal path knowledge and metadata describing digital sources containing answers constitutes the knowledge fabric. The method includes resolving ambiguity and determining actual intent of the user for the input text, from a plurality of interpretations of intent for sentences using the knowledge graph in conjunction with logical inference to achieve deep natural language understanding. The method includes finding/delivering response to the input request as to why/how unknown factors resulted in known outcome, or what outcomes are likely given known causal factors.

### CROSS REFERENCE TO RELATED APPLICATIONS

The present application is a non-provisional of U.S. Provisional Application No. 63/714,627, filed Oct. 31, 2024; all of which is incorporated herein in its entirety and referenced thereto.

The application references U.S. Provisional Application No. 62/930,742, filed Nov. 5, 2019.

A system and method for using a knowledge fabric based on a knowledge ontology, designed for deep language understanding and mechanistic causal reasoning, and a meta-knowledge repository for auditable question answering are provided herein. The method includes receiving an input text from a user, the input text specified in a natural language such as English. The method also includes building a knowledge graph that represents real world facts and associations in the form of contextually tagged and weighted knowledge propositions, in multiple knowledge domains (e.g., causality, taxonomy, meronomy, time, space, identity, language, symbols and mathematical formulas). The knowledge graph in combination with causal path knowledge and metadata describing digital sources containing answers constitutes the knowledge fabric. The method also includes resolving ambiguity and determining actual intent of the user for the input text, from a plurality of interpretations of intent for sentences using the knowledge graph in conjunction with logical inference to achieve deep natural language understanding. The method also includes finding and delivering a response to the input request as to why and/or how unknown factors resulted in a known outcome, or what outcomes are likely given known causal factors.

### TECHNICAL FIELD

The present disclosure relates to artificial intelligence systems with mechanistic causal reasoning, and in particular, to systems, methods, and devices for deriving actionable knowledge from a “knowledge fabric” using advanced or “deep” natural language understanding.

### BACKGROUND

Knowledge differs from information and data because it is immediately actionable—no additional research or analysis required. Therefor giving workers in any domain and any capacity knowledge gives them more time to use it to achieve their goals. Until now, computers could not synthesize knowledge because software and systems do not understand human language, but recognize patterns. This method and apparatus constitutes an actionable knowledge management (AKM) system that can scan public and private digital materials and fully understand them at first reading to find associations between the contents of web pages, documents, databases, spreadsheets, presentations, video and audio files and store their metadata and meaning at a fine granularity in both a metaknowledge repository and an ontology formed of a knowledge graph. AKM automatically weaves the metaknowledge repository and ontology together in a tapestry or fabric of knowledge enabling a single system to answer any question, including why, how, what, where, when and who questions, no matter how complex.

An automated system capable of answering such complex questions must be capable of deep language understanding to match the intent of the user with the meaning, the concepts in context of any digital content that could possibly provide an answer. Shallow language understanding, available through Natural Language Processing (NLP) techniques do not support causal reasoning, contextualization nor complex logic, thus cannot resolve ambiguities in NL texts nor provide a pathway to actionable knowledge. The content includes information stored in any number of different sources, thus incompatibilities between sources is one of the obstacles to deriving actionable knowledge. Another barrier is the constant flow of new information, much in digital formats, that could contribute to answers. A system that is designed to answer complex questions must keep abreast of new information through voracious reading.

The human brain is very good at observing cause and effect, in communicating their observations, understanding complex concepts contained in ambiguous symbolic language, and resolving ambiguity. Computers are not. Conventional systems that use natural language processing (NLP) use statistical models that do not attempt to understand causality nor the intent of natural language (NL) text. These systems statistically calculate the probability of any cause being associated with any effect or the probability of a phrase matching a known task or a corresponding phrase in the same or another language. Advanced Artificial Intelligence (AI) systems such as Generative Pretrained Transformers (GPT) and Large Language Models (LLM) are also based on statistical models, not meaning. Statistical models are not able to understand the meaning of written or uttered text, including causal relationships embedded in meaning, nor can they resolve ambiguity.

It has long been understood that “meaning-based” or “knowledge-based” approaches to language understanding can come closer to human competency in complex cognitive tasks including causal reasoning and language understanding. However, the computational and storage demands of these more human-like approaches were assumed to be so high as to be impossible with conventional computing hardware and software. Furthermore, strong models and extensive a-priori knowledge of phenomena such as causality are necessary to provide deep language understanding. Computational capacity has grown radically and rapidly, and the time for such systems has arrived.

### SUMMARY

Accordingly, there is a need for computationally efficient “meaning-based” or “knowledge-based” systems and methods for language understanding to approach the aspirational computational capability of delivering actionable knowledge to users. The ability to assemble and format the right bits of information to empower users to take action without further analysis differentiates knowledge from useful information and helpful data. Techniques described herein can be used to implement automated deep language understanding (DLU) with mechanistic causal reasoning to catalog reliable knowledge sources and deliver actionable knowledge based on NL requests.

Unlike conventional NLP tools that perform tokenizing, morphology and syntax analysis and lightweight semantics, and unlike machine learning (ML) tools that perform phrase analysis and fuzzy phrase comparisons, systems according to the techniques described herein analyze words, phrases and sentences in text at the morphology, syntax, semantics, context, and discourse pragmatics levels with fuzzy heuristic processes at each level. These techniques can be used to interpret meaning, answer questions, perform tasks, control internet-of-things (IoT) devices, identify key ideas and topics, identify word correlations, analyze sentiment, summarize text, translate spoken words or phrases, implement chat-bots, implement dynamic dialog, translate text, and/or analyze causality.

Various implementations of systems, methods and devices within the scope of the appended claims each have several aspects, no single one of which is solely responsible for the desirable attributes described herein. Without limiting the scope of the appended claims, some prominent features are described. After considering this discussion, and particularly after reading the section entitled “Detailed Description” one will understand how the features of various implementations are used to address issues with common computational methods.

According to some embodiments, a method is provided for mechanistic causal reasoning using techniques described herein. The method is performed by a system that includes one or more memory units each operable to store at least one program, and at least one processor communicatively coupled to the one or more memory units, in which the at least one program, when executed by the at least one processor, causes the at least one processor to perform steps of the method. The method includes receiving input data from a user. The input data describes a request that may include a case and known background information about the case. The case includes a set of causes and/or outcomes and other related information. The information about the case lacks sufficient information about why a known outcome occurred or what outcome will occur as a result of known causal factors. The method also includes determining whether the user intends to infer a predicted outcome from known causes or infer predicted causes from a known outcome.

Forward reasoning that maps known causes to inferred outcomes, or reverse reasoning that maps known outcomes to inferred causal factors, are based on a knowledge graph with subgraphs and lists. At least one subgraph is linked to another subgraph. Any related lists are linked to a subgraph. Each of the subgraphs represent a knowledge proposition including: a subject component, an associate component, a named relationship component that links the subject component and the associate component, a context component that identifies a domain of knowledge in which the association is true, a qualifier component that describes a constraint governing the relationship that further narrows the context in which the association is true, a weight component that is a probability factor of a likelihood that the proposition that the subject component is related to the associate component in the context identified by the context component, and a mechanism component that describes an instrument used or an action performed by the subject to affect the associate component.

The method also includes traversing the knowledge graph. Traversing the knowledge graph includes associating each word of the input with a lexicon object, and associating each lexicon object with a plurality of propositions in the knowledge graph. Each proposition corresponds to a subgraph, and the propositions define a relationship between the subject component and the associate component in the subgraph. Traversing the knowledge graph also includes classifying the input and associated knowledge propositions into named attributes of named specialized processing areas based on named relationships in propositions. Each specialized processing area represents a contextual component of a solution. Each attribute in each specialized processing area represents a characteristic associated with a concept defining a respective specialized processing area. A candidate is a potential component of an unknown outcome and/or unknown cause associated with the named attribute in causality. Candidates are also used to resolve ambiguity in the locations, times, identities, nature of objects and other components of understanding the intent of the input. Each candidate is associated with a modifiable confidence vector including a weight component and an emergence flag.

Processing in a specialized processing area includes activating emergent behavior by modifying the weight component of each confidence vector of each candidate. A starting value of the weight component is based on the knowledge proposition weight stored in the knowledge graph. The value of the weight component is increased each time a corroborating knowledge proposition is processed, and the value of the weight component is decreased each time a refuting knowledge proposition is processed. In some embodiments, processing in the specialized processing area also includes retrieving doping inputs and priming inputs from a context associated heuristic algorithm that generates respective doping inputs and priming inputs for the input, and applying the respective doping inputs and priming inputs to each candidate in each attribute in each specialized processing area. In some embodiments, processing in the specialized processing area also includes modifying a candidate confidence vector of each candidate in each specialized processing area based on frequency of matching between a respective candidate and at least one of: (i) a respective user input, doping input and priming input, (ii) knowledge propositions encoded in at least one subgraph, and (iii) causal path or other sequential episodic knowledge information in at least one specialized linked list to bring about emergent behavior by incrementing or decrementing a weighting component of the candidate confidence vector. Processing in a specialized processing area also includes inferring (as described above) a solution of unknown outcome and/or unknown causes based on emergent candidates for each attribute of the specialized processing areas.

Sequential episodic knowledge may refer to written information about events that have occurred or will occur in which the temporal flow of an event is described. As an example, General George Pickett's charge at the American Civil War Battle of Gettysburg included, in sequence, a prolonged artillery barrage of the entrenched Union Army defenders, the Confederate infantry advance across open ground at Seminary Hill, a brief penetration of the Union line at the “high water mark,” and a disorganized Confederate withdrawal with heavy casualties inflicted by the Union Army defenders. The techniques herein described for both learning about and responding to questions regarding specific facts in a specific event, or about general events of similar character may use advanced mechanistic causal reasoning and other logical techniques to enable the system to better understand and apply such information to newly presented requests and inquiries.

Traversing the knowledge graph may be performed at different stages in the process and includes using candidate concepts to search the knowledge graph for all subgraph propositions composed, at least in part, of the concepts for input words and the knowledge propositions extracted from the knowledge network because of their possible associations with the input. Traversing the knowledge graph (in long-term memory) is also initiated by extracting emergent candidates from each specialized processing area (in short-term memory) with a largest value of the weighting component of the candidate confidence vector. In some embodiments, traversing the knowledge graph is also initiated by detecting gaps by determining whether any attribute of any specialized processing area is required for a solution that has no candidates, and in response to determining that a respective attribute has no candidates, performing further search of the knowledge graph for possible candidates.

In another aspect, a computational system is provided, according to some embodiments. The computational system stores information in the form of a knowledge graph describing real world facts and associations in the form of contextually tagged and weighted knowledge propositions, in one or more knowledge domains including causality, taxonomy, meronomy, time, space, identity, language, symbols and mathematical formulas, that is used in conjunction with natural language understanding and logical inference to accurately determine (e.g., determination accuracy close to that of a human, or human level competence) why and/or how unknown factors resulted in a known outcome, and/or what outcomes are likely given known causal factors. The knowledge propositions are used as a basis of resolving ambiguity and determining the actual intent from among many possible interpretations of intent for sentences in natural language understanding.

In another aspect, a method is provided for mechanistic causal reasoning, according to some embodiments. The method includes receiving an input text from a user, the input text specified in a natural language. The method also includes building a knowledge graph that represents real world facts and associations in the form of contextually tagged and weighted knowledge propositions, in multiple knowledge domains (e.g., causality, taxonomy, meronomy, time, space, identity, language, symbols and mathematical formulas). The method also includes specialized ordered linked lists representing sequential episodic knowledge such as causal paths composed of sequential nodes pointing to knowledge propositions in a knowledge graph in which the sequence of the nodes corresponds to sequence in a causal path beginning with a root cause and terminating in an outcome.

The method also includes resolving ambiguity and determining actual intent of the user for the input text, from a plurality of interpretations of intent for sentences in natural language understanding, using the knowledge graph in conjunction with natural language understanding and logical inference. The method also includes generating a response to user, as to why and/or how unknown factors resulted in a known outcome, or what outcomes are likely given known causal factors, based on the resolved ambiguity and the actual intent of the user.

In another aspect, a non-transitory computer readable storage medium is provided, according to some embodiments. The non-transitory computer readable storage medium stores instructions, which when executed by a computer system, cause the computer system to perform any of the methods described herein.

In another aspect, a server system is provided, according to some embodiments. The server system includes one or more processors, memory, and one or more programs. The one or more programs are stored in the memory and are configured to be executed by the one or more processors. The one or more programs include instructions for performing any of the methods described herein.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIGS. 1a, 1b, and 1c show block diagrams that illustrate a system architecture for mechanistic causal reasoning, according to some embodiments. FIG. 1a shows multiple logical architecture tiers, FIG. 1b shows a physical component architecture of servers whereby disk storage and Long-Term Memory (LTM), and Random Access Memory (RAM) and Short-Term Memory (STM) are analogous, and FIG. 1c shows components of LTM and STM and Cache memory, according to some embodiments.

FIGS. 1d, 1e, and 1f show components of a knowledge framework that, unlike generative AI, provides complete explainability and auditability for all actionable knowledge delivered to users. The auditability includes full references for the line and paragraph of the source digital asset from which the answer is extracted and the explainability is in the reasoning steps processed to resolve ambiguity and fully understand the user's intent. Both bibliographic source references and process map are available to users for every request.

FIGS. 2a, 2b, 2c, 2d, 2e, and 2f illustrate organization of nodes and relations in a complex knowledge graph structure showing named relationships, the explicit context and the weighting, according to some embodiments. FIG. 2a shows a weighted contextual relationship, according to some embodiments. FIG. 2b shows a directed weighted, contextual subgraph with a qualifier, according to some embodiments. FIG. 2c shows contents of two directed subgraphs that are part of a hypothetical model of sunrise, according to some embodiments. FIG. 2d shows six subgraphs, two each for three ambiguous words in which the knowledge propositions distinguish the possible interpretations in each context, according to some embodiments. FIG. 2e illustrates six subgraphs whose knowledge propositions are related to specific words, foot and bridge in an input sentence though some are completely unrelated to the intent of the input sentence, according to some embodiments. FIG. 2f shows six subgraphs with knowledge propositions related to the causal relationships between antigens and antibodies, according to some embodiments.

FIGS. 3a-3h illustrate causal paths shown as directed linked nodes leading from root cause to mediating or proximal causes and finally to an outcome, according to some embodiments. FIG. 3a shows a causal path consisting of a plurality of linked directed subgraphs, according to some embodiments. FIG. 3b shows simplified diagrams of a causal confounder and a causal collider, according to some embodiments. FIG. 3c shows how several linked causal knowledge propositions lead from a root cause to an effect or outcome, according to some embodiments. FIG. 3d illustrates a causal path graph implemented as a linked list with weighted members. FIG. 3e the connections and interactions between knowledge propositions in a knowledge graph with independent causal path linked lists. FIG. 3f shows the pathway from the lexicon, invoked whenever input is received, and detailed causal path information. FIG. 3g shows a simple list structure used to optimize the exploration of alternate causal paths. FIG. 3h illustrates a segment of the knowledge graph containing causal and non-causal nodes and subgraphs connected by concept, according to some embodiments.

FIGS. 4a-4c illustrate examples of different types of causal paths in the knowledge graph, according to some embodiments. FIG. 4a is a direct causal relationship, according to some embodiments. FIG. 4b shows a causal detractor in which the factor impairs, delays or prevents an outcome, according to some embodiments. FIG. 4c illustrates a complex causal path with confounder, collider and detractor subgraphs, according to some embodiments.

FIGS. 5a-5f illustrate specialized internal processing architecture for classifying, filtering, and/or selecting candidate solutions, according to some embodiments. FIG. 5a shows a plurality of specialized multi-dimensional structures and linked heuristics, according to some embodiments. FIG. 5b shows the internal structure of a single specialized processing dimension, according to some embodiments. FIG. 5c shows examples of candidates with their vector magnitudes and directions, according to some embodiments. FIG. 5d shows examples of candidate original and current vector magnitudes and their emergence flags in a STM word list structure in Short-Term Memory (STM), according to some embodiments. FIG. 5e shows example structures in STM, according to some embodiments. FIG. 5f shows an example sentence matrix, according to some embodiments.

FIG. 6a shows a flowchart of a process of receiving input, classifying the input and performing causal reasoning based on a knowledge graph, according to some embodiments. FIG. 6b shows separate roles of human supervisor curation and automated learning and inference, according to some embodiments.

FIGS. 7a-7e illustrate an example interpretation architecture at a logical level, according to some embodiment. FIG. 7a shows interaction between permanently stored knowledge and volatile memory immediate processing space, according to some embodiments. FIG. 7b illustrates threshold logic, and FIG. 7c illustrates flow and formulas of emergence, according to some embodiments. FIG. 7d illustrates the fitness algorithm used to promote or demote candidates based on the aggregate probability that they constitute part of the intended meaning of the input. FIG. 7e shows a stratified view of language phenomena in which surface strata are easily visible and detectable using widely available computer systems and deep strata are not understood by computer software.

FIGS. 8a and 8b illustrate interoperation between model seeding and building process, and real-time knowledge use and feedback process, according to some embodiments. FIG. 8a shows how automated and human processes contribute to the permanent knowledge graph, according to some embodiments. FIG. 8b shows how initial knowledge building process and real-time causal reasoning process interact with the knowledge graph and contribute to learning, according to some embodiments.

FIGS. 9a-9e show example heuristics, according to some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals are used to denote like features throughout the specification and figures.

### DETAILED DESCRIPTION

A system capable of delivering to users immediately actionable knowledge requiring no additional research or analysis must know how concepts and contexts are associated with one another and where they can find answers in existing digital content. While there are content management systems, internet and intranet pages, search systems, analytics systems, FAQs and help systems, they are often incompatible with each other in format and even in the words they use to describe equivalent, overlapping and closely associated concepts. \

Because computer software systems process data and information, and do not process concepts in context, they are not capable of synthesizing or processing knowledge. There is no code that enables them to understand the meaning and intent of digital content nor of user requests. The actionable knowledge management (AKM) methods and apparatus described herein can scan public and private digital materials and fully understand them at first reading to find associations between the contents of web pages, documents, databases, spreadsheets, presentations, video and audio files. AKM automatically weaves them together in an ontology of concepts in context and meta-knowledge repository describing where in each document each concept and context may be found enabling a single system to answer any question, no matter how complex.

AKM uses deep language understanding to match the intent in any user request or inquiry with the meaning present in digital content that could provide an answer. As many web pages, documents and databases contain large amounts of information, meta-knowledge must be granular enough to find the right database record, document paragraph spreadsheet tab or audio or video clip to provide the exact content rather than making the user read through lengthy materials.

As digital content includes information stored in many different, often incompatible sources, the system must shield users from this complexity and use their most prominent similarity to deliver actionable knowledge: language (for example English). Natural language understanding digital content scanners can bridge technical gaps between various sources and keep up with the constant flow of new information that can contribute to answers. The same learning processes that initially learn from pre-existing digital content to formulate an ontology of knowledge and a meta-knowledge repository of sources can continuously add new digital sources to remain abreast of the constant flow of new information.

The various implementations described herein include systems, methods, and/or devices for analytics, search and deep language understanding using mechanistic causal reasoning to continuously learn real-world knowledge such as causes and effects, understand human language input and match it to the contents of digital materials containing natural language (NL) text for the purpose of delivering actionable knowledge.

Numerous details are described herein in order to provide a thorough understanding of the example implementations illustrated in the accompanying drawings. However, the invention may be practiced without many of the specific details. And, well-known methods, components, and circuits have not been described in exhaustive detail so as not to unnecessarily obscure more pertinent aspects of the implementations described herein.

Without a foundation of scientific knowledge, it is easy to mistakenly assume co-occurring phenomena are related causally or otherwise when they are not, and to mistake the nature of causal and other relationships when they are. This section describes unified mechanistic causal reasoning (UMCR) theory, including causal models used to represent prior knowledge obtained from multiple sources, techniques to capture and store it, and processes to use it effectively. The techniques described herein can be used to build automated tools and associated reasoning to infer causal relationships using scientific evidence learned through automated and supervised learning for logic-based bi-directional causal reasoning.

Bi-directional causal reasoning includes forward reasoning, from known causes to inferred outcomes, or reverse reasoning, from known outcomes to inferred causal factors. Forward causal reasoning that predicts outcomes from known causes is a clear example of actionable knowledge that goes beyond other computational capabilities such as quantitative analytics. In some implementations, on the one hand, knowledge of underlying mechanisms guides causal ascriptions, while on the other, evidence of causal relationships helps discover mechanisms. Some embodiments apply these ideas to evidence-based medicine whereby mechanistic evidence plays a prominent role in explicit hierarchies of evidence. In order to establish a causal claim, some embodiments establish both a statistical connection between the putative cause and the putative effect and a mechanistic connection that can explain the statistical connection.

In some embodiments, understanding of causal relations enable human-level intelligence, making strong artificial intelligence (AI) a plausible goal. Some embodiments use Unified Mechanistic Causal Reasoning approach to automatically answer “why” and “how” questions when the outcomes are known but not the causes. Identifying unknown causes can also be actionable knowledge.

In some embodiments, in this model, prospective and retrospective causal reasoning mean identification of basic, underlying and direct determinants or factors that influence outcomes, as in the logic rule modus ponens. The meaning of mechanism in this model is a specific action or process (Φ) likely to influence a specific outcome. A factor may have a mechanism (Φ) or an object (X) or both. Epistemologically, this monistic model treats a mechanism as an intrinsic part of a causal factor, thus is a “unified” model.

Quantitative analytics represent probabilistic models that can identify correlations but do not demonstrate causality, partly because of the absence of a concept of mechanisms associated with phenomena. The approach herein described uses language understanding techniques for mechanistic causal reasoning to answer “why” and “how” questions that are needed for advanced diagnosis and qualitative analytics. The frequent co-occurrence of a rooster crowing and the sun rising is a commonly invoked correlation that explains why quantitative models can expose and describe correlations, but cannot show causality.

Knowing that the Earth revolves around the sun and that the rotation of the Earth on its axis exposes each longitudinal area of the Earth's surface to sunlight in sequence, it is difficult to think of a rooster's crowing as causing the sun to rise. Science and knowledge informs the likely mechanisms of many phenomena, so when a system observes correlations and events that co-occur predictably, the system can quickly dismiss implausible causal factors when the mechanism is scientifically or logically unable to cause the phenomenon.

One logical principle used to determine plausibility is mechanistic possibility. If a mechanism, such as a rooster crowing, does not generate enough physical power, or if the power has limited range, as the rooster being unable to project its power over great distances, then the possibility value is too low for it to be considered a valid causal factor in the phenomenon of sunrise.

A mechanistic theory of causality posits that causal connections may be defined by underlying physical mechanisms capable of producing the effect. The case for mechanistic reasoning, especially in health science, is strong. Some conventional systems identify the component parts and operations of a mechanism and the organization is only part of the overall endeavor of developing a mechanistic explanation. The mechanism catalyzing or causing a phenomenon typically does so only in appropriate external circumstances. Some embodiments identify complex external circumstances and explore how variations affect the behavior of the mechanism. For example, in cell biology, a simple example is yeast cells carry out fermentation only when glucose and ADP are available and oxygen is not. For more complex examples, gene expression in cell biology and speciation in evolutionary biology, the relevant external circumstances are more complex.

When humans communicate by speaking or writing, they do not have to begin by sharing all their knowledge about the world so that the recipients can understand what they are saying. Speakers assume that the recipients share a huge body of knowledge about the world. In fact, communications are often tailored to address the recipients' expected or perceived knowledge level. In some embodiments, the system is designed on the premise that, for a computational system to approximate human performance in interpreting language, the system must begin with a corresponding body of world knowledge. As different people's knowledge includes different domains, facts and interpretations, the system's starting knowledge base must be very expansive.

Most sentences contain verbs, and verbs are inherently causal. Thus, causal reasoning is a fundamental part of deep language understanding (DLU). The interpreter described herein contains a knowledge graph stored as machine-readable digital data that provides this breadth of causal, pragmatic and other knowledge acquired from existing digital sources.

Pragmatics is a subfield of linguistics and semiotics that studies the ways in which context, discourse phenomena and knowledge taxonomy contribute to meaning. Pragmatics encompasses speech act theory, conversational implicature, talk in interaction and other approaches to language behavior in philosophy, sociology, linguistics and anthropology, none of which are included in traditional NLP nor in GPTs or LLMs. In some embodiments, the language interpretation process analyzes pragmatics as a central part of the interpretation process and incorporates causal reasoning as a component of equal importance with semantics, syntax and other more traditional linguistic analyses.

In some embodiments, to manage the combinatorial explosion of possibilities, the DLU interpreter makes no attempt to store nor seek any of the possible interpretations of an entire sentence or utterance in the knowledge base but describes components of meaning or intent associated with words and phrases. This mirrors the way people assemble words and phrases to communicate intent. The knowledge base, therefore, attempts to describe each possible solution of each token that is a component of any possible input text or utterance.

Input for DLU interpretation is referred to herein as “input text”, while input strictly for causal reasoning is herein referred to as “case” data. This approach assumes that most presented inputs in combination with a-priori knowledge will have a sufficient mass of solvable or interpretable components, and that the aggregation of the solved components will be sufficient to describe an acceptable interpretation of the input. It also assumes that the more accurately and dependably the system can resolve the ambiguity and polysemy of the meanings of individual tokens as components, the more accurate the final interpretation will be.

The problem of polysemy applies to words, phrases and sentences with multiple meanings. Learning and delivering individual resolutions to polysemy at the lexical word and phrase levels makes the DLU interpreter better able to solve aggregate problems of phrase and sentence ambiguity, therefore increasing the accuracy of interpretation. In some embodiments, this system resolves important components of ambiguity and polysemy through advanced causal reasoning.

### System Overview

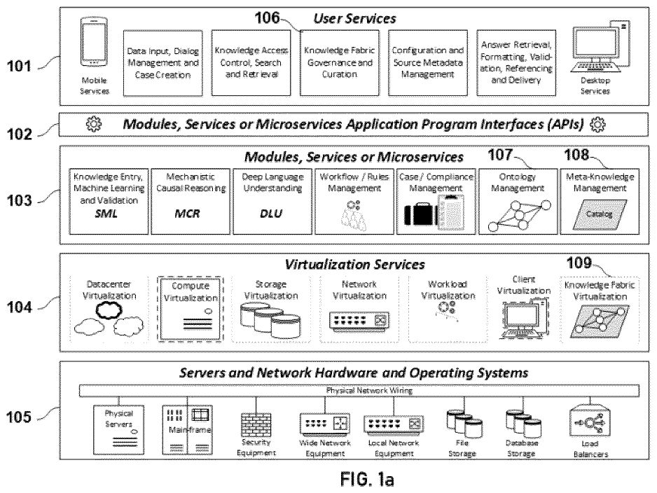

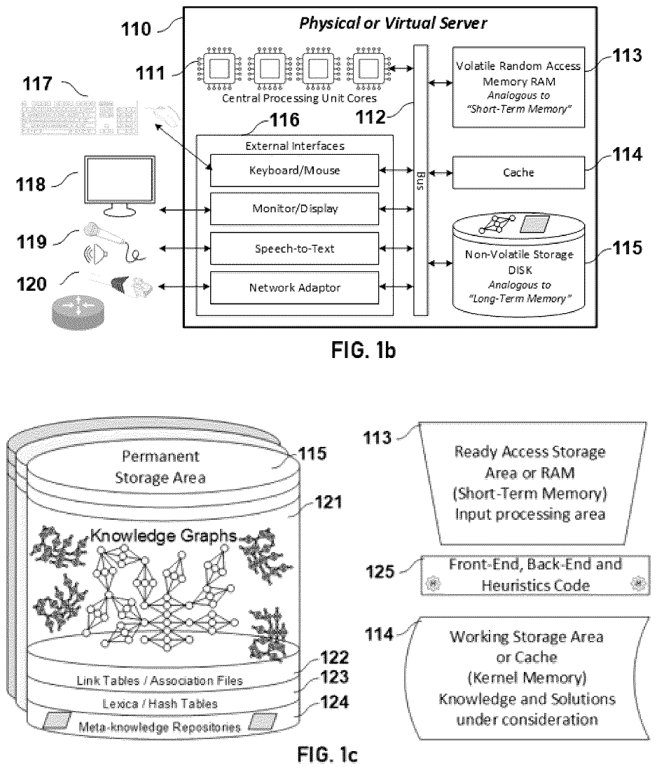

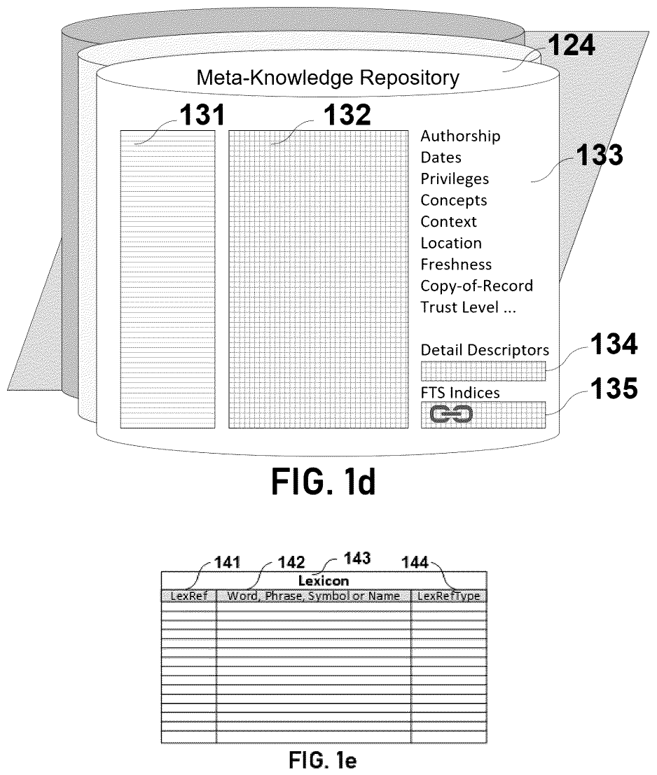

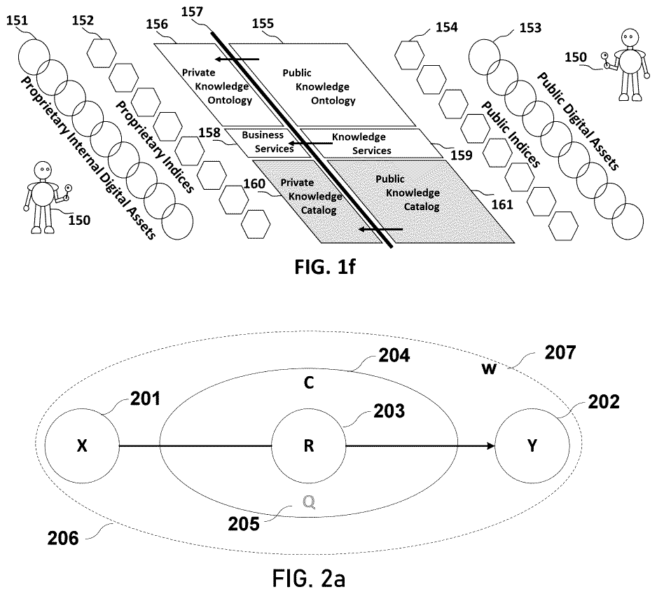

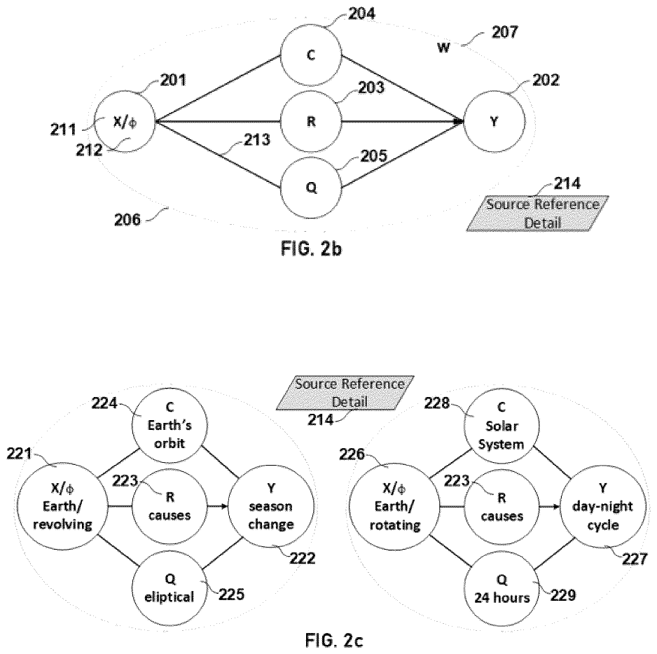

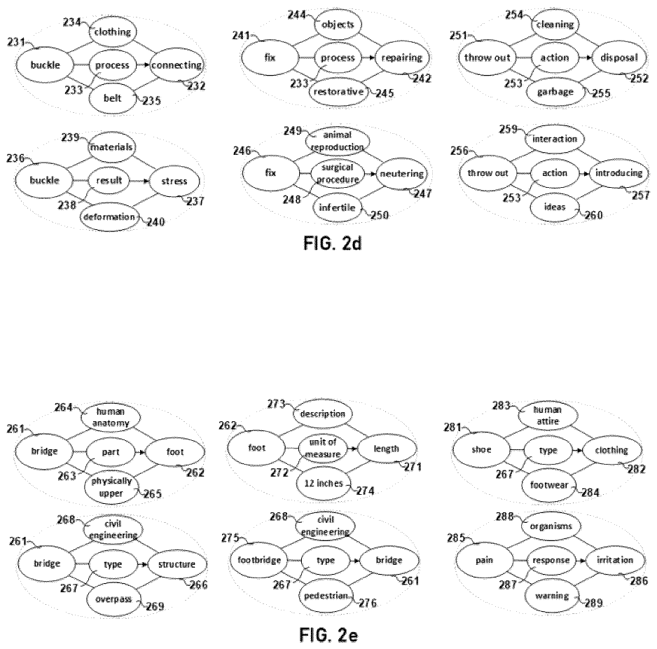

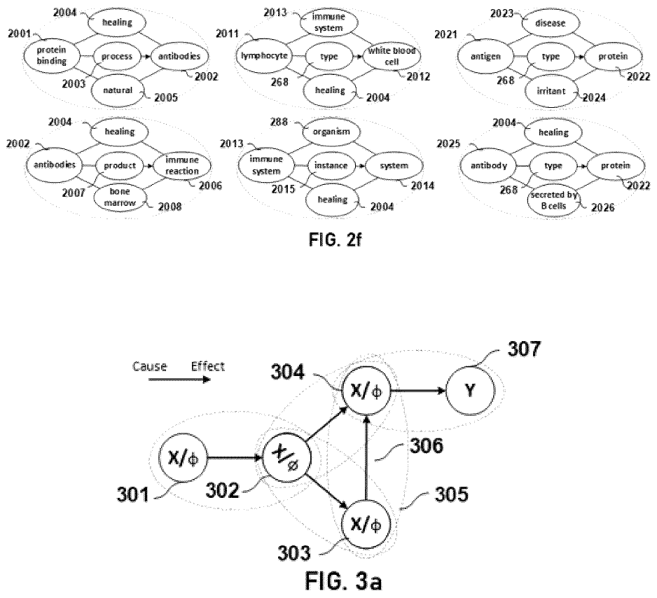

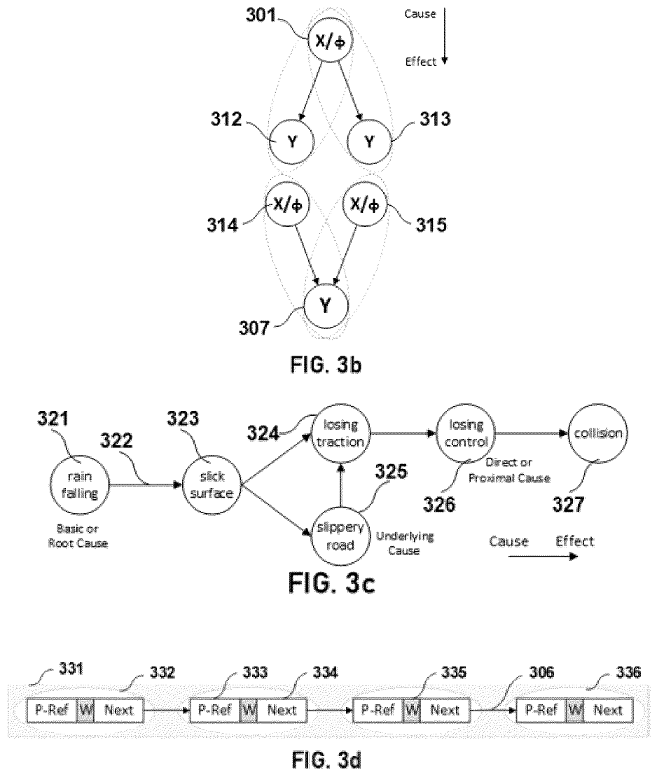

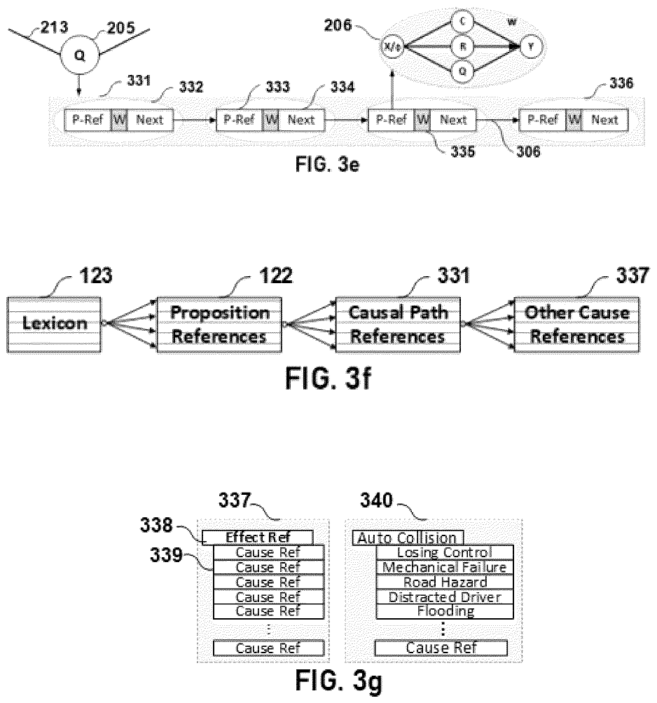

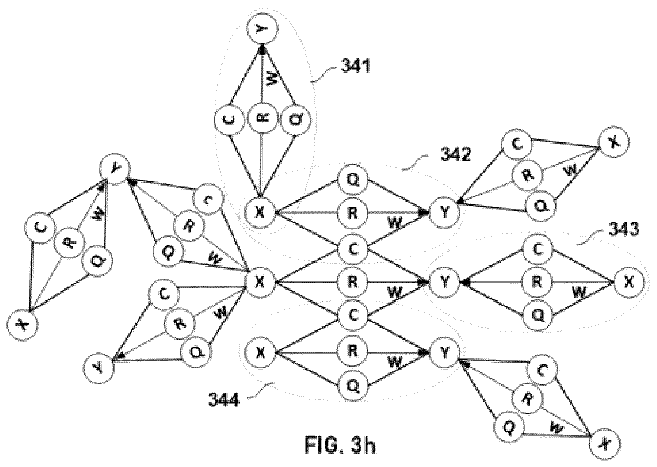

Some embodiments include one or more optimized knowledge graphs that support advanced natural language interpretation and causal reasoning that runs in a multi-tiered computing environment (an example of which is shown in FIG. 1a), on physical or virtual servers (as shown in FIG. 1b). In some embodiments, knowledge components (examples of which are shown in FIGS. 2a-2c, and 3a-3c) are structured based on a knowledge theory capable of efficiently supporting highly accurate DLU and causal reasoning across an unlimited number of contexts and knowledge domains.

Referring to FIG. 1a, in some embodiments, the system is configured to receive input data from a user describing a case and known background information about the case through interfaces including mobile based dialog interfaces 101, such as Apple and Android devices, and workstation-based visual interface. Mobile devices and workstations connect to the modules, services or micro-services layer 103 through application program interfaces 102 or APIs.

In some embodiments, the computer system modules or services 103 are configured to determine whether the user intends to generate a predicted outcome from known causes or generate predicted causes from a known outcome. For example, the computer system modules or services 103 may provide a user interface 101 configured to receive an indication from a user to generate a predicted outcome from known causes or generate predicted causes from a known outcome.

In some embodiments, the computer system modules or services 103 are configured to automatically determine a forward or reverse causal reasoning. The process components or modules, services or micro-services 103 can be deployed to virtualized 104 or physical infrastructure 105 in a “cloud” hosted data center or on-premises data center. The system may be used in help desk request resolution, qualitative analytics and causal reasoning for scientific discovery and development of new therapies as an interpretive artificial intelligence with Deep Language Understanding (DLU) causal reasoning and actionable knowledge management. The combination of the knowledge ontology 107 and meta-knowledge repository 108 form a virtual knowledge fabric 109 capable of delivering actionable knowledge.

AKM is a modular interpreter supported by dialog-based workload and workflow-driven components, according to some embodiments. A workload manager is responsible for maintaining the overall state of each process in the system and notifying users when input is needed and when solutions are ready for review. AKM APIs provide device-independent user interfaces for both mobile interactions, mostly speech driven, and visually rich desktop interactions that may use voice and keyboard input.

Each of these components fills an important role in knowledge fabric governance and curation 106 by giving users access to review and curate inferred knowledge gathered during the initial training process of scanning all relevant digital content, and later in the recurring update stage of ingesting newly arrived information. The newly acquired knowledge is stored in two different forms: 1) as knowledge propositions in the ontology 107 and 2) as meta-knowledge 108 records describing the concepts and contexts in digital assets at a granular level (Note: digital assets are treated as “sources” of knowledge, thus the word sources will almost always refer to digital assets).

In some embodiments, AKM constitutes an operational system architecture and structure (FIG. 1a) for storing and processing proposition information in digital, analog, or other machine-readable formats, and includes:

a multi-tiered processing architecture with infrastructure and virtualization tiers 104 underlying the modules or services 103, APIs 102 and user services tiers 101 including a non-volatile permanent storage area 105 and 115, analogous to human long-term memory (LTM) for retaining the knowledge graph 121. In some embodiments multiple knowledge graphs 121 may be used to separate proprietary information applicable to a single commercial, government or private entity from public information available to any user without restriction. In some embodiments multiple separate physical storage media 115 may be used to store separate knowledge graphs 121. All these are managed with unified virtual knowledge management 109 tools.

AKM uses optimized structures in the internal architecture of computer servers 110 as shown in FIG. 1b, according to some embodiments. In some embodiments serverless computing may replace 110, especially when used in conjunction with code containers such as Docker and container orchestration systems such as Kubernetes. In some embodiments, CPU cores 111 (sometimes called processors) process data passed across a system bus 112 between Random Access Memory 113 (RAM), which is analogous to a human Short-Term Memory (STM). The bus 112 also mediates information exchange with a cache 114 and permanent storage 115 which is analogous to human long-term memory (LTM). The bus 112 connects the computing input and output to external interfaces 116 including keyboards and mice 117, display monitors 118, microphones and speakers 119 to receive and reproduce sound such as voice signals, and/or network adaptors 120 for local area and wide area interconnectivity, according to some embodiments. While not necessary to achieve suitable performance, some embodiments include Graphical Processing Units (GPUs), Field Programmable Gate Arrays (FPGAs), and/or Application Specific Integrated Circuits (ASICS), in addition to, or instead of, the CPU cores 111. In the following description, the operations described as being performed by the CPU cores 111 can be performed by any type of processor, according to some embodiments.

It is noted that the physical and/or virtual infrastructure described herein are only provided for illustration, as a generic framework for efficient computational capabilities, digital, and/or analog processes.

In some embodiments, the computer system is configured as one or more memory units 104 and 105 each operable to store at least one program.

In some embodiments, the computer system is configured as at least one processor 111 communicatively coupled to the one or more memory units 113 and 114, in which the at least one program 103, when executed by the at least one processor 111, causes the at least one processor to receive input data from a user describing a case and known background information about the case through interfaces including mobile based NL dialog interfaces 101.

In some embodiments, the computer system modules or services 103 are configured to determine whether the user intends to generate a predicted outcome from known causes or generate predicted causes from a known outcome. For example, the computer system modules or services 103 may provide a user interface configured to receive an indication from a user to generate a predicted outcome from known causes or generate predicted causes from a known outcome.

In some embodiments, the computer system modules or services 103 are configured to determine a forward or reverse causal reasoning.

In some embodiments, the AKM permanent storage area 115 consists of a volatile working cache storage area 114 called Kernel Memory, for processing input information and temporary storage and analysis of not yet validated portions of said information;

In some embodiments, the AKM permanent storage area 115 consists of a volatile ready access storage area 113 (such as RAM or random access memory), analogous to human short-term memory (STM) for retaining a portion of the information from said working cache storage area. STM 113 is the focal area for interpreting language and causal reasoning. STM 113 may receive information copied from said working cache storage area. copied from said permanent storage area or from both.

In some embodiments, the AKM permanent storage area 115 consists of one or more lexica 123, each comprised of letters, symbols, words, numbers, and combinations thereof with a tightly interconnected lexicon hash table 123 to expedite search of said lexicon.

In some embodiments, the lexicon 143 is a matrix consisting of at least three columns, each of which contains defined information. The first column 141 contains unique sequential numeric references used as a pointer that can be used by external processes to rapidly find a specific lexical item stored in the same row. The second column 142 contains the word, phrase, symbol or name of the lexical item. Each lexical item, therefor, represents a concept. The third column 144 contains the type of lexical reference for the same row. In some embodiments Lexical Reference Types may include word, phrase, symbol, list, image name, video name or sequential episodic knowledge such as a causal path among others.

In some embodiments common causal paths are encoded as linked lists in which the head object is a root cause and the tail object is a possible final outcome. In this linked list, each node consists of a reference to a knowledge proposition that represents a causal factor, and a link to a second node which points to a proposition reference that that is a possible effect.

Referring to FIG. 1d, one or more meta-knowledge repositories can be configured to contain a list of sources 131 or digital assets 151/153 (a source list) in which the asset is named and a pointer to the storage location of the asset is provided. meta-knowledge associated with each source listed in 131 is stored in a data table 132 in which identifying information about the contents of the source are permanently stored. In some embodiments the contents of the meta-knowledge table 132 may describe the following characteristics 133 of the content of the source 151/153: authorship; dates of creation and update; security access privileges and authorized roles of users; concepts contained in the source; context descriptors generally describing the domain of knowledge included in the source; geographical information about the contents of the source; the freshness or continuing applicability of the source based on when it was originally created and whether or not updates include changes that have occurred since its creation; whether or not this version of the digital asset is the “copy-of-record” or if it has been superseded by an updated version; and the trust level of the accuracy and/or bias of the contents.

In some embodiments, the meta-knowledge repository 124 may contain a separate table of detail descriptors for the contents of a source. Detail descriptors may apply to tables and columns in a database and the concepts represented by the values stored in the tables and columns. For documents, detail descriptors may include chapters, sections and paragraphs and the concepts represented by the values stored in each of these portions of a document. For spreadsheets, detail descriptors may apply to tabs, areas, rows and columns and the concepts represented by the values stored in the tabs, areas, rows and columns. For presentations detail descriptors may apply to sections and each slide and the concepts represented by the values stored in the sections and each slide. For video and audio sources, detail descriptors may include sections or segments and the concepts represented by the values stored in the sections or segments.

In some embodiments, front-end 101 and back-end 103 code for the modules, services and APIs 102 are stored in a code-base 125 and executed on servers, virtual servers or serverless platforms to support the AKM system.

In some embodiments, the meta-knowledge repository 124 may contain a separate table of links to separately stored Full-Text-Search indices 135 that enable users to find the exact location in a document, spreadsheet, video or audio file that applies to their specific request or inquiry.

In some embodiments the AKM system uses bots 150 to scan and read digital information sources to understand their contents for use in intelligent services that deliver actionable knowledge. Each distinct source file, web page or database is considered to be a distinct a digital asset 151/153. When the digital asset is proprietary because it contains non-public information, it is treated as a proprietary digital asset 151 and the detailed meta-knowledge indices generated by the bots 140 are treated as proprietary indices 152 so that security mechanisms 101, 103 and 105 can be used to prevent unauthorized disclosure.

When the digital asset is public, such as a public website, document, media file or database, it is treated as a public digital asset 153 and the detailed meta-knowledge indices generated by the bots are treated as public indices 154 so that disclosure of the contents is not limited by any form of access restrictions.

In some embodiments when any of the information contained in the scanned and read digital information contains knowledge that does not yet exist in the systems existing knowledge ontology, it may be added as either public knowledge 155 or private knowledge 156. In some embodiments, business services 158 include the ability to identify proprietary knowledge as well as the ability to selectively permit and restrict access to the knowledge. Knowledge Services 159 include the learning capabilities that dispatch bots 150 and process the information they gather. These may use stored procedural code 125.

In some embodiments information about the digital assets or sources are catalogued in a private knowledge catalog 160 or a public knowledge catalog 161 by the knowledge services 159. These catalogs are separate meta-knowledge repositories 124 used to support causal reasoning about specific observed phenomena and events, question answering, help desk ticket resolution, customer care and analytics based on automatically understanding the contents of a combination of public 153 and private digital assets 151.

In some embodiments logical barricades using physical or virtual firewalls 157 are used to prevent private information from being disclosed to unauthorized users. When information is delivered to authorized users, detailed reference information from the private knowledge catalog 160 or public knowledge catalog 161 is provided with the information for verification, explanation and further research.

In some embodiments, the same bots 150 that are used to learn the conceptual contents of digital assets and record them in one or more knowledge catalogs 160 can also be used to identify concepts and contexts that are not yet included as logical propositions 206 in the knowledge network 121. When such new knowledge is acquired through reading digital assets, the new knowledge may be added to a temporary area in the knowledge network 121 where newly inferred knowledge may be validated through searching other digital assets 153 or through human validation or curation.

### Knowledge Encoding Scheme

Referring next to FIG. 1c, DLU interpreters require exhaustive information about physical and abstract things in the real world as well as information about linguistic patterns and structures and their causal, taxonomical and other interrelationships. For efficient computational processes, knowledge must be stored intelligently and efficiently. The DLU interpreter stores the interrelationship information in a knowledge graph 121 whose nodes consist of NL logical proposition subgraphs associated by explicit links, built in a framework of semantic primitives that relate to the full range of natural phenomena and human experiences. This knowledge graph 121 is analogous to Long-Term Memory (LTM) in humans. In some embodiments, the forward or reverse causal reasoning is based on traversing said knowledge graph 121 with subgraphs and associated indices and lists designed to optimize direct access to the relevant knowledge propositions in the graph 121.

In some embodiments a non-volatile permanent storage area 115 may include a meta-knowledge repository 124 containing information about digital content assets, also known as “sources” and how the information contained in each source can be used to answer questions posed by users. In some embodiments multiple meta-knowledge repositories 124 may be used to separate proprietary information applicable to a single commercial, government or private entity from public information available to any user without restriction. In some embodiments multiple separate physical storage media 115 may be used to store separate meta-knowledge repositories 124.

For the AKM interpreter, the semantic base primitive is “intent” as expressed in words using its parent primitive, “communication”. In other words, when people communicate using words, the thing conveyed is their intent. The AKM interpreter processes the speech or text communicated to determine intent based on the words chosen. The knowledge network 121, therefor, contains the solution set as a whole and the a-priori weights are the Bayesian distribution. In some embodiments, copying a subset of permanently stored propositions from LTM 115 into specialized processing areas in STM 113 includes populating a section of the Bayesian network which is the aggregate of potentially meaningful propositions applied to any given input.

Because of the expansiveness of the knowledge network and the fact that only small portion of that knowledge will be needed to interpret any given sentence or paragraph, in some embodiments, the salient information discovered through searching the knowledge network is copied into a temporary processing area that is an optimized STM 113. While knowledge or information in LTM 115 is persistent, the contents of STM 113 are frequently changed and modified during processing. For performance purposes, in some embodiments, a working storage area 114 or cache is also used to store information that may be needed for multiple successive or parallel reasoning or interpretation processes.

In some embodiments, the system is configured to associate each word of the input with a lexicon object 123 and associating each lexicon object with a plurality of propositions in the knowledge graph 122. Each proposition corresponds to a subgraph FIG. 2a, and the propositions define a relationship 203 between the subject 201 component and the associate component 202 in the subgraph.

In some embodiments, the atomic or basic components of this information are encoded in a lexicon 123 holding lexical items 142 (in FIG. 1e) or tokens. These tokens can be letters, words, numbers and characters that are not alpha-numeric, but are used to represent understandable concepts in communication. For processing efficiency, in some embodiments, the lexicon 123 is accompanied by a hash table 123 for rapid information search and retrieval. In some embodiments, more than one lexicon may be used.

In some embodiments, in order to access knowledge in the knowledge graph, the lexicon 123 is used to provide direct access to each proposition in the network associated with that lexical item or token through a link table or association file 122. Non-lexical object tokens can also be used to access the knowledge network. This direct access is analogous to a content-addressable mechanism for reading information in human LTM.

In some embodiments, the lexicon 123, association file 122 and knowledge graph 121 are dynamic building blocks of correct interpretation. They are dynamic because through machine learning (ML) or supervised machine learning new lexical items can be added, new propositions can be added and confidence values of propositions can be changed. The primary processes of reasoning and interpretation are based on comparing input with this graph of propositions 121, determining the likelihood that specific propositions 206 apply and are true, then delivering the set of the most applicable and likely propositions 206 as the solution to inquiries, including causal inquiries or interpretation of the original intent.

In some embodiments the machine learning is continuous because new knowledge propositions 206 are automatically associated with existing propositions 206 in the knowledge network 121 if they share one or more objects with matching lexical items as concepts 201 or 202 or contexts 204. This implies that any newly learned proposition 206 must be associated with prior knowledge to become part of the knowledge network 121. This accretive or cumulative learning process is what enables continuous growth in the knowledge base and does not require any cut-off date as is required in many neural models such as generative pre-trained transformers (GPT) with Large Language Models (LLM).

Just as people use knowledge about underlying mechanisms to infer factors and outcomes, this process taps into stored “hypothetical” models that are preconceived, and pre-validated expectations about how things work. In some ways, this is not unlike quantitative analytics. Analysts and data scientists spend a significant amount of time up front gathering and organizing the information needed for reports, visualizations and dashboards. They build and test formulas for optimally expressing meaningful indicators in the output. The optimized “Online Analytical Processing” data structures, report formats, formulas and choices of visualizations constitute the a-priori knowledge needed for successful quantitative analytics.

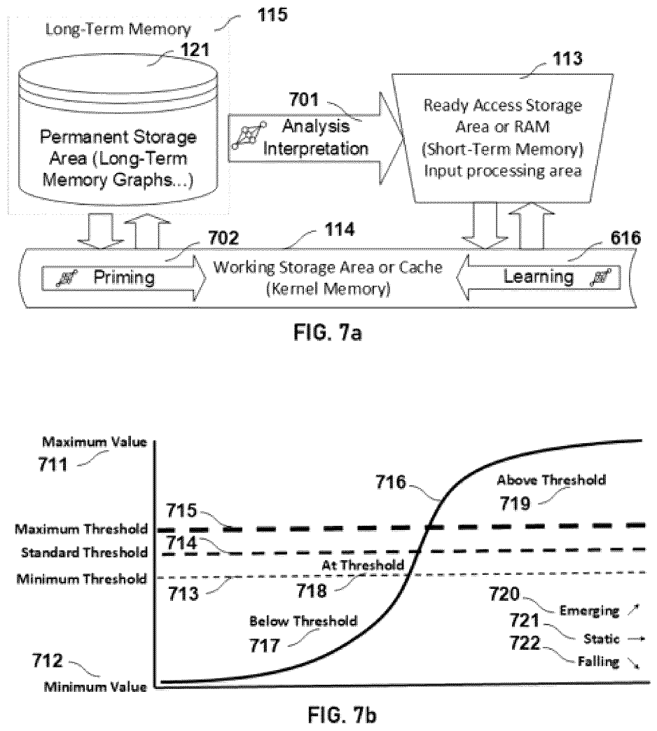

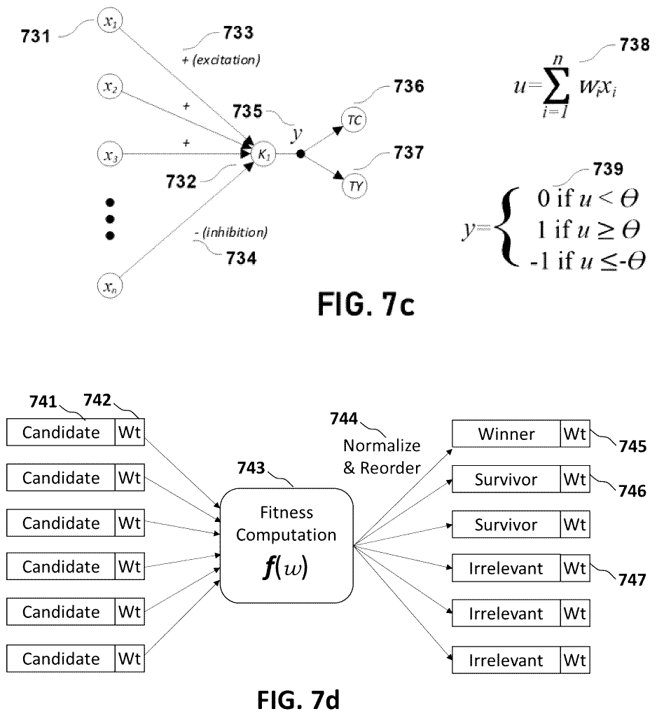

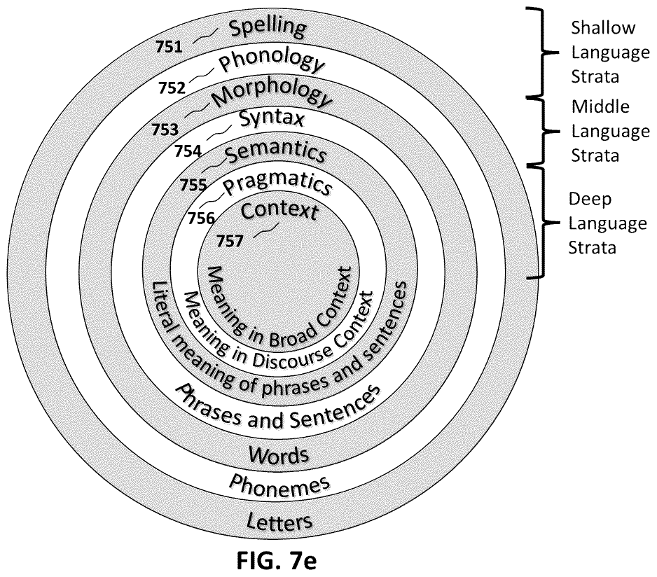

In some embodiments, each domain and context, such as surface transportation and driving, has a hypothetical model which comprises the set of directed causal subgraphs whose C object 204 (FIG. 2b) matches the name of the domain or context. Thus, extracting the hypothetical model is a simple search of the graph for subgraphs with C objects 204 matching the identified domain or context. Search for environmental factors involves a “spreading activation” process (FIG. 7b) in which the system extracts from LTM subgraphs that are directly connected to the X 201, Y 202 and C objects 204 of the directed subgraphs in the hypothetical model.

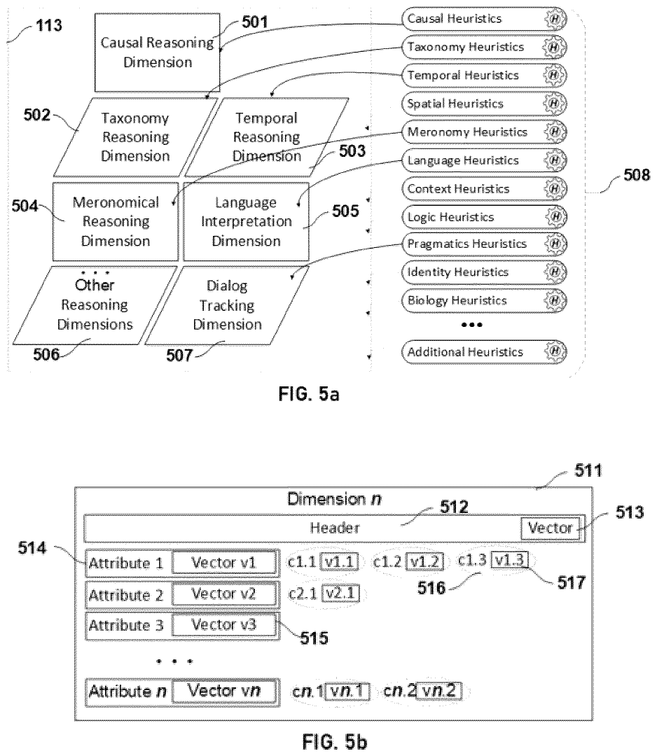

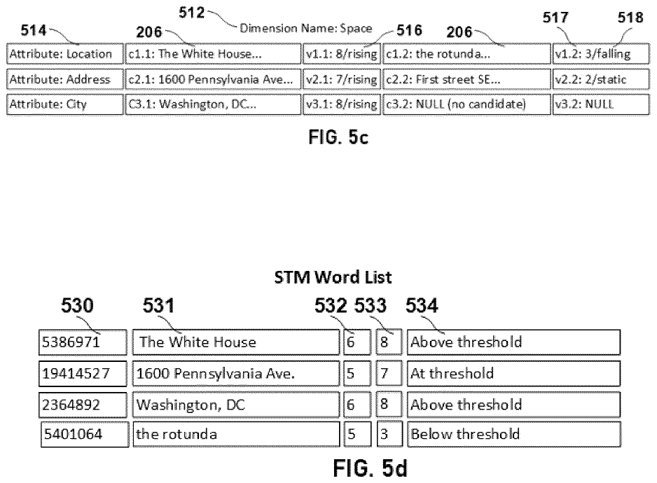

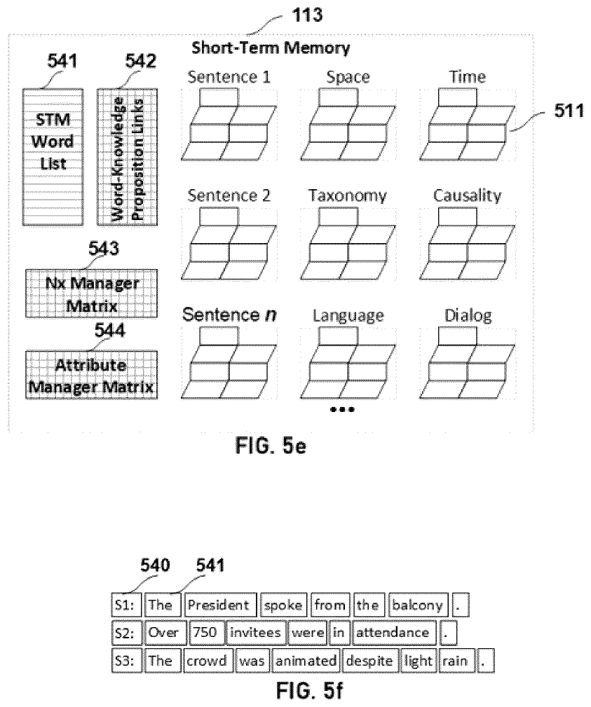

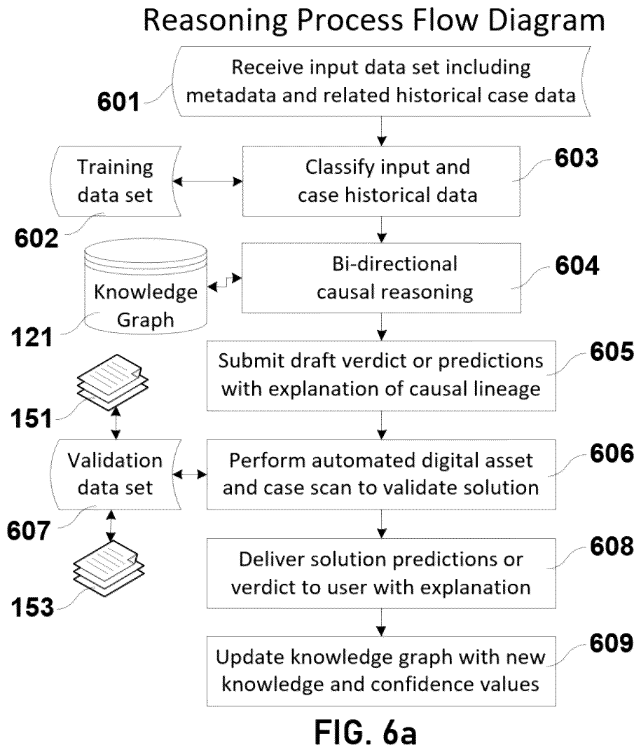

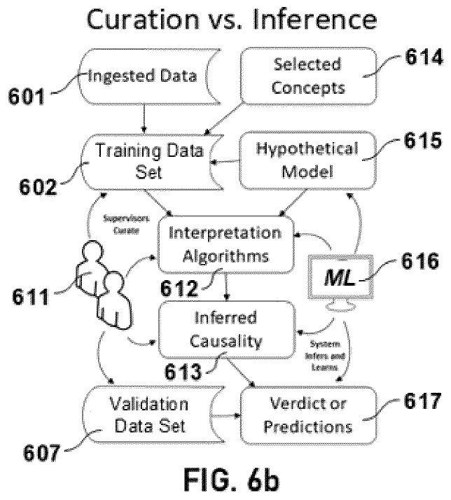

In some embodiments, for processing input, AKM first loads the hypothetical model into STM 113 as a session state, then classifies (606 in FIG. 6a) the verbal description and observational learning inputs into the session for text analysis, and numeric data into session for quantitative analysis. In this way, some embodiments rapidly identify inputs that correspond to model elements and begin identifying outcomes ranking causal candidates (516 in FIG. 5b) even as data is being acquired.

Mechanisms are verbs usually with -ing endings. As an example, a pairing of a component (X) 211 and a mechanism (Φ) 212 is X=“battery” and Φ=“discharging”. This factor might be used in reasoning about an inoperative automobile. Each knowledge proposition can be read as a natural sentence: X 201 “is a” R 203 “of” Y 202 “in the context of” C 204 “that is” Q 205 “with a probability of” W 207.

In some embodiments, the forward or reverse causal reasoning is based on said knowledge graph 121 with subgraphs. The system may be configured to associate each word of the input with a lexicon object 123 and associating each lexicon object with a plurality of propositions in the knowledge graph 121, wherein each proposition corresponds to a subgraph, wherein propositions define a relationship between the subject component 201 and the associate component 202 in the subgraph.

### The Universal Knowledge Theory

The theory behind the AKM Knowledge Representation scheme used to electronically store real-world knowledge, is that high performance can be achieved if all the knowledge is stored in the minimum possible efficient format to support brain-like processing, simulating “spreading activation” of excitatory and inhibitory electrical impulses. As knowledge is symbolically represented in words and sentences in a human language to facilitate knowledge sharing and transfer between people, and as there are imperfections in the languages and symbols humans use to communicate, ambiguities arise that may be difficult for humans to resolve and very difficult for machines to resolve, a key capability needed for deep language understanding is the ability to automatically resolve ambiguity. Consistency in format lends itself to computational efficiency, thus AKM captures and stores knowledge in a format consistent with the following Universal Knowledge Theory.

Referring next to FIG. 2a, the Universal Knowledge Theory states the following regarding all physical things and abstract concepts that exist:

All things 201, physical and abstract, can be represented by unique words, symbols or phrases in human language.

There is nothing, physical or abstract, that is not related to some other thing 202.

A taxonomy of things or objects can be defined to describe category and part-whole relationships to connect all objects into a single interconnected graph or network 121.

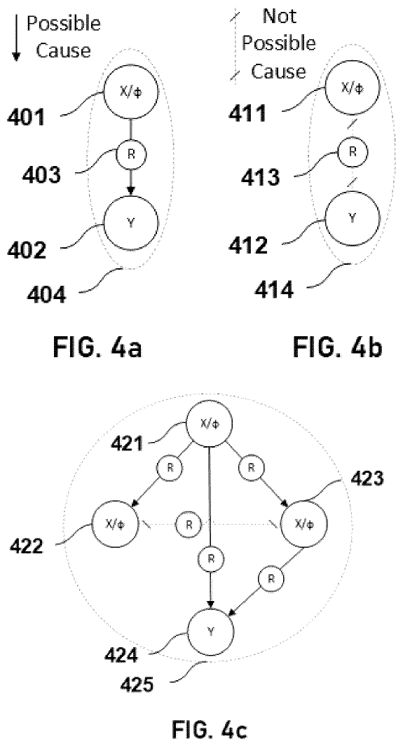

Causal chains or paths (FIG. 4a, 4b, 4c, 4d) can be articulated which describe how physical things and abstract concepts interact with other things leading from actions to reactions.

Each relationship between two things can be described in such a way that an explicit relationship “R” 203 ties each pair of things together.

Explicit relationships “R” 203 can be described by a finite set of words that logically and linguistically express the nature of each relationship.

Relationships are governed by context “C” 204, such that a valid relationship between two things in one context may be invalid or different in another context.

Relationships may be further Qualified by constraints “Q” 205 that describe unique characteristics of the relationship or link relevant additional or external information.

All the objects in a relationship 206, and the descriptors of the relationship, context and constraints can be represented by human language words, symbols or phrases.

The ordering of a pair of objects, a relationship, a context and constraint constitute a single directed proposition in which the first or X 201 object is the subject concept, the second Y object 202 is the associated concept and the R 203, C 204 and Q 205 objects uniquely define the proposition.

For each proposition, a level of probability, confidence or belief may be applied and the confidence value expressed as a weight “W” 207.

The interconnectedness of this theory lends itself to modeling as a graph and implementing in a graph or relational database. FIG. 2a emphasizes how the context defines the relationship R 203 between two objects, X 201 and Y 202, and other relationships may exist between X 201 and Y 202 in the same context or in different contexts, according to some embodiments. Referring next to FIG. 2b, the weight component 207 is a probability factor of the likelihood that the proposition that the subject component 201 is related to the associate component 202 in the context identified by the context component 204, according to some embodiments.

The Weight component 207 is used for comparing alternative interpretations to select knowledge propositions that are most likely to represent the original intent of the input. The Weight 207 can also be used in logical comparisons to determine likelihood, possibility or impossibility of causes and mechanisms being ascribed to a known outcome.

In some embodiments, the AKM system represents knowledge in a concise formal logic proposition format based on the theory. While the graph format favors a graph database platform for implementation, big data such as Hadoop, relational databases and flat databases are also options because the format is simple and adaptable. Nothing in this disclosure should be interpreted as requiring a certain commercial database, server, network, programming language or other standard.

An example formula for representing this universal theory of knowledge is shown below, according to some embodiments:
For all objects X,
(((((X is related to at least one other object Y)
by an explicit relationship R)
within a specific context C)
qualified by a constraint Q)
with a probability of W).

In some embodiments, a context component 204 identifies a domain of knowledge in which the association is true.

A node is an element in a graph that has a name and a value and may be connected to any number of other name/value pair nodes by vertices. A vertex is a named relation which may be a simple semantic role such as agent, instrument or object, or a complex causal role such as catalyst, initiator or contributor, or a negative role such as barrier, impediment or terminator. The use of specific semantic and causal roles makes the language understanding model and the causal reasoning model much more robust by expressing more nuances in causality. Because this knowledge representation scheme includes a massive collection of compact statements of propositional logic, the structure of nodes and subgraphs is useful for pictorial description shown in FIGS. 2a-2c. Some embodiments use a graph database for implementation.

Referring next to FIG. 2b, in some embodiments, each of the subgraph objects 206 represent a knowledge proposition including a subject component 201, associate component 202, named relationship component 203 that links the subject component and the associate component, a context component 204, a qualifier component 205 that further narrows the context in which the association is true, a weight component 207, and a mechanism component 212.

In some embodiments, this encoding scheme for real-world knowledge stores information as knowledge proposition subgraphs and objects in machine-readable format optimized for use by expert system, interpretation and learning algorithms. This is analogous to permanent or LTM in humans in which knowledge is learned and remembered. In this interconnected network or graph of explicit concept subgraphs 121, connections are formed by juxtaposition of objects in relationships that form directed subgraphs. These subgraphs are defined by their nodes, in which each node is named by an explicit object that consists of a token that can be lexical (a word, symbol, number or phrase) or non-lexical tokens, such as machine-readable images, videos and sounds, according to some embodiments.

In some embodiments, the knowledge proposition 206 is represented computationally in a sequential manner by ordering the objects such that the sequence begins with the X object 201 as subject, and sequentially followed by the remainder of the objects. In some embodiments, the objects contain explicit role labels (X, R, Y, C, Q, W) when implemented as a relational database or a tagged structure such as JSON or XML, or the label of the object role can be inferred from position in the subgraph 206 if all subgraphs are structurally identical. The token nodes can be represented in a file independently from the subgraphs that represent the propositions associated with the tokens. In some embodiments, this independent representation is a list of words, symbols and phrases, called a lexicon 123, and the tokens are alternately described as lexical items. In some embodiments, the independent representation may also contain non-lexical objects.

In some embodiments, a lexicon 123 is used to represent the basic elements or nodes of knowledge because all human knowledge is represented by words, symbols and phrases, and if humans cannot describe it using a word, symbol or a phrase, they cannot share it using verbal communication. As language evolves to accommodate new knowledge and concepts, new words and phrases are coined. In some embodiments, the DLU interpreter invokes ML to add new words, phrases and other tokens to the lexicon to represent knowledge that is new to the system or new to the language. In some embodiments, the lexicon also contains non-lexical items, such as lists, linked lists sounds and images to broaden interpretation capabilities.

The name of any of the lexical items described above may be formed by a single letter, number or symbol, or a string of letters, numbers or symbols, and is valid as long as the name is recognizable by someone as representing a physical or abstract thing or concept in the universe. The specific usage of nodes in knowledge subgraphs may be tailored for a specific class of relationships or a context. Referring back to FIG. 2b, in some embodiments, causal relationships include a component X 201 that is a cause or a predecessor in a causal path to an outcome Y 202 that may operate as a mediator or intermediate causal factor. X 201 and Y 202 are joined by a named relationship R 203 within a governing context C 204 with an optional qualifier Q 205. This molecular relationship forms a directed subgraph in the overall knowledge graph and is assigned a weight W 207. The ordering of the objects 206 represents the direction of the causal path and when the causal relationship is truly bi-directional, which is rare but possible, two separate subgraphs, one with X 201 and Y 202 reversed, are needed to express the bi-directionality, according to some embodiments.

### Causal Knowledge

Because the AKM causal model is mechanistic, a causal factor includes both the component X 218, a noun and the mechanism φ 212, a verb usually ending in -ing, according to some embodiments. The subject or X object 201 of causal relationships may be formed of a component noun X alone or a mechanism verb Φ alone, but the preferred structure embodies the combination of X and Φ. Non-causal relationships may also use the structure of X and Φ or any other unique structure suited to the nature of the relationship. Two words joined, such as “Earth rotating” or “batter swinging”, form causal factors as phrases that act as natural X objects 201. In fact, there are many multi-word idioms in the lexicon that form valid X objects 201 in molecular subgraphs such as “up in the air” and “down in the dumps”, each forming a discreet concept that serves as the subject of molecular knowledge propositions. Compact phrases of this type are common in the AKM knowledge model.

This approach treats each phenomenon as occurring in a domain and context. As an example, as shown below in Table 1 and in FIG. 2c, within the domain “celestial bodies” and the context Earth's “Solar System”, the phenomenon of sunrise can be defined in a finite set of knowledge propositions as directed subgraphs. Some propositions describe the taxonomy in which the related objects exist while some describe causal factors:

See Table 1

TABLE 1
Some knowledge pertaining to “sunrise”

| X | R | Y | C | Q | W |
|---|---|---|---|---|---|
| celestial body | instance | object | universe | Natural | 8 |
| star | instance | celestial body | Cosmos | emitting light | 7 |
| nuclear reaction | mechanism | emitting light | Star | Continuous | 7 |
| planet | instance | celestial body | Cosmos | emitting no light | 6 |
| orbit | motion | celestial bodies | Space | Constant | 5 |
| galaxy | group | star systems | universe | gravitationally bound | 7 |
| Milky way | instance | galaxy | universe | local to humans | 5 |
| star system | group | celestial bodies | Galaxy | gravitationally bound | 8 |
| Solar System | instance | star system | Milky way | local to humans | |
| Sun | instance | star | Solar System | Central | 5 |
| Earth | instance | planet | Solar System | Inhabited | 8 |
| Earth | route | around the sun | Solar System | Earth's orbit | 6 |
| Earth | motion | revolving | Space | around the sun | 7 |
| Earth | motion | rotating | Space | Daily | 6 |
| Earth revolving | causes | season change | Earth's orbit | Elliptical | 7 |
| 221 | 223 | 222 | 224 | 225 | |
| (FIG. 2c) | (FIG. 2c) | (FIG. 2c) | (FIG. 2c) | (FIG. 2c) | |
| Earth rotating | causes | day-night cycle | solar system | 24 hours | 6 |
| 226 | 223 | 227 | 228 | 229 | |
| (FIG. 2c) | (FIG. 2c) | (FIG. 2c) | (FIG. 2c) | (FIG. 2c) | |
| sunrise | event | day-night cycle | Earth | day's beginning | 5 |
| sunset | event | day-night cycle | Earth | night's beginning | 5 |
| sunrise | event | day-night cycle | Earth | night's ending | 5 |
| sunset | event | day-night cycle | Earth | day's ending | 5 |

The following examples illustrate using logically precise if not completely natural phrasing to articulate two of these knowledge propositions: “Earth rotating causes the day-night cycle in the context of the solar system that is 24 hours” and “Sunrise is an event of the day-night cycle in the context of Earth that is night's ending.”

Things as complex as the functions and interaction of celestial bodies cannot be fully described in a few knowledge propositions shown above. For example, the need for an observer for the concepts of sunrise and sunset to be completely meaningful in human terms, cannot be fully described. The complexity of the astronomical and simply observable phenomena is not reflected in the small subset of the knowledge graph herein. Observers use a combination of senses and life experiences to interpret, remember and understand the meaning of “sunrise”. But the ability of a plurality of such knowledge propositions to express natural phenomena and human experience, even when incomplete, serves as a foundation for both causal reasoning and deep natural language understanding, and as such, supports accumulating more knowledge (i.e. concept learning) to further improve the quality of artificial intelligence and causal reasoning functions.

The subjects X and activities Φ may be articulated as follows:
X1 is “Earth” and Φ1 is “revolving around the sun” and Φ2 is “rotating on its axis”
X2 is “Sun” and Φ3 is “emitting light” and while humans understand that the sun is in motion vis-à-vis the galaxy it is not critical to understanding the phenomenon of sunrise.
X3 is a phenomenon called sunrise that marks the night's ending and the day's beginning.

In some embodiments, the mechanism component 212 describes an action that the subject component 211 is performing to affect the associate component 202.

In some embodiments the set of causal relations (R) 203 and 223 may include cause, instrument, agent, means, catalyst, mechanism, product, byproduct, output, response and result among others. But non-causal relation types may also support causal reasoning.

The two core linguistic phenomena deeply connected with the ways humans express and understand causality are semantics and pragmatics. Semantics is the language phenomenon concerned with meaning, especially concerned with the agents, instruments, objects and outcomes of actions. Pragmatics is concerned with the truth values representing the logic and statement of logical propositions of ideas of what can, did or will occur, or not, in the real world as expressed symbolically by spoken utterances or written text based on the peoples' language strategies used to express those ideas, or more broadly, their intent.

In some embodiments, knowledge related to both semantics and pragmatics is embedded in the knowledge network wherein subgraphs explicitly describe semantic and pragmatic phenomena as knowledge propositions. Examples include the following (shown in FIG. 2d). The word “buckle” 231 as a verb can be interpreted as a connecting 232 process 233 in the context of clothing 234 that involves a belt 235. In a different context, buckle 236 can be interpreted as a result 238 of stress 237 in the context of materials 239 that causes deformation 240. Words with multiple meanings are inherently ambiguous and require application of context and other cues to determine which of the possible meanings the speaker or writer intended to convey.

The word “fix” 241 is a process 243 of repairing 242 in the context of objects 244 (which is understood to be a universal construct embodying both physical and abstract objects 244) that is restorative 245. Fix 246 refers to a surgical procedure 248 of neutering 247 in the context of animal reproduction 249 that becomes infertile 250. The idiom “throw out” 251 is an action 253 of disposal 252 in the context of cleaning 254 that involves garbage 255. In the same conference room as one person throws out an empty soda can, a participant may throw out an idea. In this case, throw out 256 is an action 253 of introducing 257 in the context of interaction 259 that involves ideas 260.

These three examples represent a small subset of the knowledge propositions describing the words “buckle”, “fix” and “throw out” in the knowledge network, but are intended to show how the contextual marking of these knowledge propositions enables resolution of ambiguity in ways not possible with other knowledge representation schemes. Resolution of ambiguity is the core contribution of semantic and pragmatic processes this approach uses for both language understanding and causal reasoning.

The example shown above illustrates how AKM knowledge propositions support the resolution of linguistic ambiguity. The next example in FIG. 2e shows a small subset of the knowledge that would be used to resolve ambiguity in an explanation that a patient may state to a podiatrist: “I feel pain in the bridge of my left foot when I wear my dress shoes”.

The word “bridge” 261 is ambiguous, and, in addition to the foot 262 there are several parts 263 of the human anatomy 264 referred to as bridge (for example the nose has a bridge). In the case of the foot, the bridge is in the upper 265 area. Bridge 261 is also a structure 266 type 267 described in civil engineering 268 that is used to pass over 269 roads, conduits or natural features. The first knowledge proposition in FIG. 2e applies directly to the patient's statement and the proposition about a bridge in civil engineering does not, illustrating the differentiation of knowledge used to resolve ambiguity.

“Foot” 262 is also ambiguous, and while the drawing does not show a knowledge proposition that describes the foot 262 as part of human anatomy 264, such propositions exist in the knowledge network to distinguish the body part from the unit of measure 272 that is used in description 273 to represent things of 12 inches 274 in length 271. Combinations of foot 262 and bridge 261 can exhibit further ambiguity such as the term “footbridge” 275 which, in the context of civil engineering 268 is a type 267 of pedestrian 276 bridge 261.

To resolve the ambiguity of foot and bridge, in some embodiments, other knowledge propositions 206 can both nudge the contextually consistent propositions toward emergence and trigger heuristic processes 508 (see FIG. 5a) that serve to promote or “heat up” related knowledge and disqualify or “cool down” pragmatically unrelated knowledge propositions. They effectively create a “resonance” that favors the best interpretations of foot and bridge. The heating up and cooling down of candidates 516 mimics a natural selection process embodied in genetic algorithms in which the fittest candidates 516 survive.

As illustrations of these influences in the current example, among many other related knowledge propositions in the knowledge network 121, one describes a shoe 281 as a clothing 282 type 267 in the context of human attire 283 that is worn on the foot 284. This linkage will heat up knowledge propositions 206 whose context is related to humans including the foot 262 of which bridge 261 is a part 263, and cool down a foot 262 used as a unit of measure 272 and a bridge 261 that exists in the context of civil engineering 268. There may also be a “clothing” heuristic 508 that builds a new temporary special processing area (see 511 in FIG. 5b) with attributes 514 that can use candidate knowledge propositions 206 to answer questions about dressing and attire, or an anatomy heuristic 508 that can use candidates 516 to answer questions about body parts.

Another knowledge proposition 206 that will heat up human interpretations of foot and bridge will be the last shown in this series. There will be many propositions 206 associated with pain 285, most of which will directly or indirectly refer to the context of organisms 288. The fact that pain 285 is a response 287 to irritation 286 in the context of organisms 288 that acts as a warning 289 will, in addition to the favoring the correct interpretation of the statement, support causal reasoning as the mechanism 219 of the pain 285 is likely to be irritation 286 caused by the shoe 281 on the bridge 261 of the patient's foot 262. Additional specific causal propositions 206 could reinforce this causal inference, as could a “pain heuristic” 508 that builds a new temporary special processing area 511 with attributes 514 that can use candidates 516 to answer questions about its nature, sources and acuteness.

Many knowledge propositions support causal reasoning without explicitly containing members of the set of causal relations (R) 203, 223, 233, 238 and 253. This is especially the case in complex knowledge domains such as human biology. As an example, FIG. 2f shows that protein binding 2001 is fundamental to antibodies 2002 that participate in the process 2003 of natural 2005 healing 2004. Antibodies 2002 are a product 2007 of an immune reaction 2006 in the context of healing 2004 supported by the bone marrow 2008.

The system contains many knowledge propositions 206 that define this process in enough clarity, completeness and expressiveness to enable robust natural language interpretation and causal reasoning. New knowledge can be added to the same knowledge graph 121 without impacting the existing knowledge. Some of the example illustrations in FIG. 2f describe things at the cellular level, such as a lymphocyte 2011, a white blood cell 2012 type 268 in the immune system 2013 needed for healing 2004. Knowledge propositions describe instances 2015 of systems 2014 such as the immune system 2013 possessed by many types of organisms 288 to contribute to healing 2004.

Again, the processes of classifying these knowledge propositions into specialized processing areas 511 where heating and cooling heuristics 508 bring about their emergence replicates human cognitive processes associated with language understanding and causal reasoning. The links between these examples and prior examples demonstrate the interconnectedness of the knowledge which is an important reason for using a knowledge graph 121 to replicate knowledge in the massively interconnected human brain.

There may be many knowledge propositions that add important associations to causal reasoning processes. As an example, healing may be associated with injury, disease or both. For injuries there may be sets of knowledge propositions associated with cellular regeneration, cell division and mitosis. For diseases 2023 in which an antigen 2021 is a type 268 of protein 2022 that acts as an irritant 2024, the biological mechanisms of healing 2004 involve natural processes in which antibodies 2025 are a protein 2022 type 268 that is secreted by B cells 2026 to respond to the irritant 2024. Actionable knowledge is derived from making meaningful connections between concepts in context.

The way knowledge propositions support causal reasoning without explicitly containing members of the set of causal relations (R) 203 is by supporting semantic and pragmatic reasoning that corroborate or refute causal reasoning processes through the heating and cooling processes described earlier.

Semantically, an “object” may be an agent, instrument or object. Any pairing of an X object 201 and an activity (Φ 212) form a complete factor and may be treated as a candidate 516 in a causal chain, according to some embodiments. Factors with a known mechanism and an unknown object, or a known object with an unknown mechanism can also be causal candidates 516 and outcomes, but the confidence in the verdict diminishes, according to some embodiments.

In some embodiments, the AKM causal model is an ontology of interactions between factors and outcomes that form causal chains or paths to comprise a hypothetical model. Causal chains are examples of sequential episodic knowledge and can be represented as directed graphs as shown in FIG. 3a.

The elements in the model are weighted with confidence values to permit fuzzy reasoning, and may include tags that identify the factors as “basic”, “underlying” or “direct” determinants, but this may also be inferred by position in a causal chain based on proximity to the outcome. Each causal chain is tagged with one or more context names which are within a larger domain. Contextualization permits inheritance, so salient details that may apply to many objects and/or mechanisms may be encoded at a higher level and not repeated for each factor.

In some embodiments, the causal model for this approach contains complex definitions of sequential episodic knowledge, with factors representing an object 218 and mechanism 219, and causal chains tied to specific phenomena operating within one or more named contexts 511 in a larger domain of knowledge. This representation permits similar or identical factors to have completely different behaviors and outcomes in different contexts. Note that in a causal path based on subgraphs 206, when name of the Y element 202 of one subgraph 206 matches the X element 201 of another, they form a chain. As the graph grows with greater breadth of knowledge, the key is finding the right chains, or the best chains through heuristics 508 that favor correct solutions through associations with a preponderance of corroborating knowledge.

In some embodiments, ML techniques can be used to establish correct solutions a-priori and store the validated causal chains in optimized digital form in permanent storage 115. In some embodiments these permanently stored validated paths are stored as linked lists whose head is a lexical item 123 including a pointer to the linked list.

Granularity of descriptions of phenomena refer to the scope of the description such as global vs. local and population vs. individual and organism vs. system vs. organ vs. tissue vs. cell. Matching the granularity of the of phenomena with the factors inferred to be causally related is critical to determining the validity of the model, and ultimately to the success of the UMCR process: mismatched granularity can lead to incorrect retrospective verdicts or unrealistic predictions. In some embodiments, the system's ML uses natural language accounts to infer possible causes and their salience without regard to granularity. In the curation or supervised ML process, some embodiments provide subject matter experts tools to tune the model by matching granularity.

FIGS. 3a-3c show examples of causal paths as graphs, according to some embodiments. The causal path is sequential episodic knowledge shown in FIG. 3a consists of five directed nodes in a causal path. Each of the nodes points to a knowledge proposition subgraph 206 in the knowledge graph, four nodes as causal factors and one as the outcome. In this path, the root cause 301 leads to a mediator 302. The mediator at 302 leads to two additional mediators, 303 and 304. Each of the paired nodes enclosed by dotted lines 305, includes a directional arrow 306. The final outcome 307 is shown as the result of all the predecessors in the causal path.

As each of the causal nodes points to a knowledge proposition subgraph 206 in the knowledge graph, mediators 302, 303 and 304 are the Y objects of the subgraphs in which 301 and 302 are the X objects, and 302, 303 and 304 are the X objects of their own subgraphs. This is possible because the exactly matching word that is the name of the node is what makes them effectively the same object or concept whether in the X 201 or Y 202 position, thereby implicitly linking them in the broader knowledge graph 121.

### Confounders and Colliders

The present application has mechanisms for identifying causal phenomena such as co-occurrence, colliders and confounders, mediators and environmental factors, according to some embodiments.

Confounders: Referring to FIG. 3b, In causal paths, a confounding factor 301 or lurking variable is a causal factor that influences more than one outcome 312 and 313, possibly causing a spurious association. In forward causal reasoning confounders constitute a logical OR stated as either causal factor 301 can cause effect 312 or 313 and they are treated as separate valid paths. As an example, strenuous activity or poor nutrition can independently cause a reduction in a person's energy level. And even though both may be present, they are independent factors in the outcome.

If both causal factor A or causal factor B are required to cause effect E, such as thrust and lift and specific air density are independently needed to generate enough lift for an aircraft to take flight, the resolution requires a logical AND, and is treated differently than unrelated confounders, according to some embodiments. For complex causality, the mechanisms and interplay of causal factors are especially important to capture. The directed molecular subgraph model supports complex causality using “required” qualifiers (Q) 205 in cause-effect subgraphs. No matter how many causal factors are required for an outcome, the “required” qualifier forces the system to resolve for each.

In some embodiments, This system includes a Confounder Heuristic: When two or more outcomes (E1, E2 . . . . En) 312 and 313 are independently associated with or caused by the same causal factor 301, the system will search the model for any direct or indirect causal path between the outcomes. If none are in the model, the system will search digital assets 151/153 for causal paths from each outcome (En) to each other outcome (En). If digital asset search turns up no causal paths, node 301 is a confounder.

As used herein, generating a predicted cause form a known outcome may refer to AKM causal reasoning used to identify factors that account for an outcome and explain why an outcome occurred, according to some embodiments. The reasoning process explicitly aims to differentiate primary causes and secondary causes such as “confounders”. Deconfounding experiments seek to block secondary causes or “backdoors” to demonstrate the outcome would occur absent their influence. While this system is designed to process input from such experiments, the primary purpose is to accept as input data describing normally occurring phenomena and use a-priori knowledge to identify and rank causal factors that could account for the phenomenon. In some embodiments, The system has no formal capabilities to run such experiments nor block confounders/backdoors but can use context to favor more likely causal paths.

In some embodiments, the system is configured to find sequential episodic knowledge such as causal paths by traversing the knowledge graph.

Colliders: In causal paths, an outcome 307 or mediator 307 is a collider when it is causally influenced by two or more causal factors 314 and 315. The name “collider” refers to the symbology in graphical models (FIG. 3b), in which arrows from more than one factor 314 and 315, often unrelated to one another, lead into the same effect node 307. That effect node, whether an outcome or a mediator in the causal path is the collider. A collider does not necessarily imply causal association between the predecessor variables.

In some embodiments, the system includes a Collider Heuristic: When two or more independent or unrelated causal factors (causal factor A or causal factor B) 314 and 315 are found in the input and have direct paths to the same outcome (Y) 307 the system will search the model for any direct or indirect causal path between the causal factors. If none are in the model, the system will search digital assets for causal paths from each causal factor (Xn) 314 to each other causal factor (Xn) 315. If digital asset 151/153 search turns up no causal paths, the factors are colliders and are treated as independent, even if both factors appear in the input case.

Referring to FIG. 3c as an example, the first node 321 is “rain falling”. This is a cause 322 of a “slick surface” 323. The next causal arrow points to an effect which is also an intermediate cause “losing traction” 324 as well as an instance of a specific slick surface, a “slippery road” 325. The concept “slippery road” brings us into the context 204 of “surface transportation” (not shown) which would not have been present in 321 or 323. A “slippery road” 325 also points to an effect which is also an intermediate cause “losing traction” 324. The propositions associated with “reduced traction” will point to the context 204 of “driving” (not shown) which is a member of the taxonomy of “surface transportation”. Alternatively, a detracting causal factor in 323 or 325 may be a proposition stating that a “slippery road” 201, “impairs” 203 “traction” 202. A contributing causal factor may be “slippery road” 201, is a “contributor” 203 to a “driver losing control” 202 in the context 204 of “driving”. “Losing Control” 326, the proximal cause may be a “precursor” of a “collision” 327 in the context 204 of “driving”, the final outcome of this causal graph.

This example illustrates how the same concept can act as both X 201 or cause in a plurality of directed causal subgraphs 206, and Y 202 or outcome/mediator in a plurality of other subgraphs. In this example, the domain and context are “surface transportation” and “driving”. The set of all subgraphs whose C 204 objects match the domain and context are the hypothetical model for that context. Viewing the network shown in FIG. 3h, subgraph 341 shares an X 201 object with subgraph 342. Subgraph 342 has such intersections at X 201, Y 202 and C 204. Subgraph 343 shares a common Y 202 element with an unnamed but related subgraph 206, and subgraph 344 shares common C 204 and Y 202 elements with other subgraphs 206. Again, the commonality consists of exactly matching words as named objects in subgraphs that represent concepts.

The knowledge propositions illustrated in FIG. 3h are independent logical statements of discreet phenomena that could be causes, effects or neither. In some embodiments, specialized linked lists FIG. 3d may be stored separately in permanent storage 115 rather than knowledge propositions 206 in a knowledge graph 121. These linked list structures may be used to optimally represent sequential episodic knowledge such as causal paths in the AKM system,

FIG. 3d shows a causal path 331 consisting of a linked list of specialized nodes whose head 332 is presumed to be a root cause and whose tail 336 is assumed to be the outcome or ultimate effect. The pointer to the causal path itself is a reference 141 to a named item 142 in the lexicon 143 whose Type 144 is “CausalPath”. Each object in the causal path 331 contains a proposition reference (P-Ref 333) and a pointer to the next link in the path 334. The proposition references are pointers to knowledge propositions 206 in the Knowledge Network 121. The tail of the list 336 is the outcome or ultimate effect and is characterized by a NULL value in the Next position. The sequence of the list is indicated by arrows 306 but is explicitly contained in the Next 334 object value which is a pointer to the next node in the causal path.

In some embodiments, a causal path linked list 331 may be contained in the Q object 205 of a knowledge proposition 206 as shown in FIG. 3e. As with other objects in each knowledge proposition 206, the Q object 205 is a lexical reference 141. When the Lexical Reference Type 144 is a Causal Path 331, the linked list will be directly addressed by the lexical reference 141. Thus, access to a causal path 331 is initiated through a knowledge proposition 206.

Each specialized node 332 in a causal path 331 begins with a Proposition reference 333 that points to exactly one knowledge proposition 206 in the AKM knowledge graph 121. To avoid repeated cycling or looping through knowledge propositions 206 already incorporated into the solution, knowledge services 159 check the list of previously visited knowledge propositions 206 and skips any that have already been analyzed.

FIG. 3f shows a high-level view of the associations between AKM objects used to optimize the causal reasoning process. In some embodiments, beginning with the lexicon 123, every word and other lexical item 142 is associated with any number of knowledge propositions 206 through association tables 122. Any knowledge proposition 206 may be linked to a causal path 331 through its Q object 205. As any single lexical item 142 may have multiple knowledge propositions 206, there may be more than one causal path 331 associated with a single concept 142.

As any element of a causal path may be associated with other causal paths or other sequential episodic knowledge as shown in FIG. 3b, AKM provides a process and supporting data structures to identify and compare confounders and colliders. The data structure is a list of other possible causes 337. FIG. 3g shows that this list has a head 338 which names the effect or outcome and any number of possible causes 339 as lexical items 142. Again, processes are in place to avoid looping through circular references.

An example of a list of other possible causes is shown in 340 in FIG. 3g.

In some embodiments, to find causal factors, confounders, other than the predecessor in the current path there is a four step process: 1) opening the knowledge proposition 206 in the P-REF; 2) inspecting the X object 201 of that knowledge proposition 206; 3) identifying all causal path references 339 that may apply to this as an effect 338; 4) analyzing each other causal path for applicability in the present case.

As used herein, generating a predicted outcome from known causes may refer to advanced model search heuristics using inherited characteristics in the component and/or the mechanism to expose positive or negative causal impacts that do not appear in the causal paths or sequential episodic knowledge in the model, according to some embodiments. Specifically, the model may show that a build-up of oil or water or ice on a road surface can reduce traction, and reduced traction can cause a driver to lose control of a vehicle, and losing control of a vehicle can cause a collision.

In some embodiments, the system's ability to perform deep natural language processing enables the use of models and subgraphs that are not exact spelling matches but different forms of the same word or a synonym, thus conceptually linked. This is accomplished through the “morphological analysis” process, synonym matching, similarity heuristics and environmental heuristics.

FIG. 3h illustrates how the same concept can act as both X 201 or cause in a plurality of directed causal subgraphs 206, and Y 202 or outcome/mediator in a plurality of other subgraphs 206, according to some embodiments. In this example, the domain and context 204 are “surface transportation” and “driving”. The set of all subgraphs 206 whose C objects 201 match the domain and context are the hypothetical model for that context. Viewing the network shown in FIG. 3h, subgraph 341 shares an X object with subgraph 342. Subgraph 342 has such intersections at X, Y and C. Subgraph 343 shares a common Y element with subgraph 342, and subgraph 344 shares common C and Y elements with other subgraphs.

### Impossibility or Implausibility as Negative Causality

Negative Causality: Some of the illustrations (e.g., FIGS. 4a-4c) show simplified causal paths as directed subgraphs to emphasize the relationship between a cause 401 and an effect or outcome 402. In some embodiments a single knowledge proposition 206 is enough to encode a direct cause to effect relationship, The presence of a named relationship 403 makes the subgraph 404 more robust and expressive than an unnamed directional arrow. When a causal factor comprised of either a subject component X 218, a mechanism Φ 219 or both 411, has a negative impact on an outcome 412, the relationship R 413 describes the nature of the negative impact, in a refuting subgraph 414 reducing the likelihood of the outcome or rendering it impossible or implausible. When the knowledge is available, the magnitude of the impact is typically stored in the Q object of a fully articulated knowledge proposition, according to some embodiments.

In some embodiments, the system includes a Negative factor Heuristic: The AKM system uses a brain-like process of both “activation” and “inhibition” in which candidates 516 and solutions “heat up” as the aggregate weight of confirming knowledge grows, and “cool down” as negative or refuting knowledge accumulates. The direct or indirect impact of obstacles, barriers and terminators is intrinsic to the causal path analysis, and can affect the rise of candidates 516 to solutions, and become part of the explanations that describe how the solution was selected. The expressive names of negative factors in causality further increases the robustness of the overall causal reasoning process.

Combinations of positive and negative factors in the hypothetical model are uncommon in automated causal reasoning systems but are essential to form complete models of real-world phenomena. While FIG. 3c shows a model in which reduced traction is represented as a contributor, the detailed description suggests an alternative detractor, according to some embodiments. The path in FIG. 4c could represent a topical ointment applied to a small laceration 421 that makes the skin itch 422 and also reduces bacteria 423. Itching the skin 422 adds bacteria, thus detracting from the ointment's efficacy at 423. Using the topical ointment 421 both contributes directly to healing 425 and reducing bacteria 423 also contributes to the healing 425. The decision to train the system to use positive or negative factors may be purposeful during seeding and curation as part of supervised learning, but inferred knowledge propositions may fall either way depending on the contents of the selected training set, according to some embodiments.

### Complex Analysis

Root cause analysis demonstrates that many phenomena have multiple levels of depth or intermediate causes between the outcome and original or root cause. Sometimes one can draw a clean line from the root cause to the outcome, but many phenomena are far more complex, and require a “network” model of causes.

Linearity in causal models is represented by the arrows (process focus), yet many causal models, weather predicting for example, have many factors contributing to a single outcome (complex systems focus), and the factors often influence one another creating chaotic patterns that defy directional path models in favor of constraint-based reasoning.

For this reason, some embodiments use more breadth in the model and greater variety of types of conceptual knowledge that can be analyzed as part of determining causality thereby contributing to developing better predictive and descriptive solutions. The distributed graph nature of the model is more interconnected and brain-like than, for example, relational database models that have limited and somewhat arbitrary interconnections between conceptually linked data objects. Besides brain-like structure, AKM uses emergent brain-like processes, according to some embodiments.

The benefits of clearly understanding the intent of spoken and written language and clearly understanding how cause and effect operate to make our verbs more meaningful are mutually reinforcing. Deep language understanding contributes to causal reasoning through detecting synonymy, resolving the meanings of idioms and establishing taxonomical relationships in which objects that are not in the input are closely related to and may inherit characteristics of similar objects. At the same time, causal reasoning can improve the quality of language interpretation by expanding the understanding of unstated assumptions in the input that assume the readers or listeners understand the impacts of interactions between nouns and verbs in the input. Both directions draw benefits from a brain-like process using specialized processing areas to analyze each dimension of salient knowledge.

Referring to FIGS. 5a and 5b, specialized processing areas 511 in STM 113 provide an expandable set of distinct reasoning frameworks as dimensions. The basic dimensions include causality 501, taxonomy 502, time and space 503, part-whole or meronomy 504, Language 505, and/or other reasoning dimension(s) 507 as needed to address the context of the input.

Each dimension 511 has one or more heuristics 508 tailored to that area of knowledge with functions that answer specific questions related to that area coded as heuristics 508.

An example of one such heuristic, in addition to the confounder, collider and negative factor heuristics described above is the Environmental Factor Heuristic: The system automatically searches the model for possible environmental factors beyond the hypothetical model, and inside or outside the domain of the input phenomena that could impact the outcome or key factors in the causal path. Environmental factors could include time-of-day and outdoor light levels, season of the year, calendar phenomena such as end-of-month and end-of-year and weather factors. This is possible because of the interconnected structure of the knowledge network 121 in which each outcome (Y) 202 and causal factor (X) 201 and mechanism (Φ) 219 is characterized by its core attributes 514: concepts that are part of the global taxonomy.

Related objects in the knowledge network 121 are also characterized by their attributes 514, any of which may shed light on, and possibly influence the solution, especially when subordinate classes of objects inherit descriptive attributes from super-ordinate classes. As an example, In some embodiments in the contextual dimension 511 of Time attributes may include “event time”, “beginning”, “ending”, “duration”, “time of day”, “season”, and so on. The input or other sources may provide answers to any or all of these questions which improve the system's ability to fully understand and solve the situation.

This is a brain-like approach because the brain also exhibits electrical signal flow that follows neuronal link associations wherever the dendrites lead. Innovators and poets are examples of people well known their ability to tap into the more remote associative links as part of their cognitive processes. This capability of making associations across multiple subject areas is core to understanding human's creative thinking capability, and ability to infer complex causal associations.

Referring next to FIGS. 5b and 6a, in some embodiments, the system may be configured to classify 606 the input 601 and associated knowledge propositions 206 into named attributes 514 of named specialized processing areas 511 based on named relationships in propositions. The term Nx is used as shorthand for an n-dimensional matrix which is the structure of the specialized processing areas. In some embodiments, each specialized processing area 511 represents a contextual component of the solution named in the header 512. In some embodiments, each attribute 514 in each specialized processing area 511 represents a characteristic associated with a concept defining a respective specialized processing area 511. A vector in the specialized processing area 513 is used to track the progress of emergence in that context, according to some embodiments.

In some embodiments, a candidate 516 is a knowledge proposition 206 that may answer the question is a potential component of an unknown outcome and/or unknown cause associated with the named attribute 514. In some embodiments, each candidate 516 is associated with a modifiable confidence vector 517. Each attribute 514 also has a vector 515 used to track the progress of emergence in that attribute 514, according to some embodiments.

FIG. 5c shows examples of actual values in a special processing area 511 dimension named “space” 512 with several attributes 514, each with one or more candidates 516 and their associated candidate vectors 517. The vector has two parts, the magnitude 517, and direction 518, according to some embodiments.

FIG. 5e shows an example STM word list 541 in FIG. 5e, according to some embodiments. The example STM word list 541 is an ordered group of lexical items or words including input objects in which 530 is a unique index for each lexical item in the matrix and 531 is the input as received or a related lexical item extracted from the knowledge network 121 that could contribute to understanding the input. The original magnitude 532 is the W value 207 of the highest instance of the word as X 201 in propositions 206 extracted from the knowledge network. The current magnitude 533 and emergence flag 534 evolve through the interpretation and causal reasoning processes, according to some embodiments.

Referring to FIG. 5e, in some embodiments, the AKM structures in STM 113, including the STM word list 541, a matrix of all the words in the input, an association table between words and knowledge propositions 542 in which the words appear, and a pair of hierarchically organized matrices 543 and 544, responsible for managing of all the associations between individual words, knowledge propositions 206 and their locations as candidates 516 in attributes 514 of specialized processing areas 511. A plurality of specialized processing areas 511 (e.g., Sentence 1, Sentence 2, . . . , Sentence n, Space, Taxonomy, Response, Time, Causality, and Self), are used to efficiently process the complex heuristics 508 used in interpretation and causal reasoning.

The ability to classify words and process them in contextually relevant specialized processing areas 511 is fundamental to robust NL understanding and helpful in effective causal reasoning. Adding geographic knowledge enables system to identify location in the input and associate the location with a causal factor, an outcome or both. Adding the ability to sequence events temporally 503 is equally important. Understanding meronomy to establish part-whole relationships 504 that affect causality also improves the causal reasoning process. In various embodiments, the system design includes heuristics 508 for some or all of these.

FIG. 5f shows an example sentence matrix, according to some embodiments. The example sentence matrix is a structure in STM 113 which is an ordered group of input objects in which 540 is a unique index for each row in the sentence matrix and 541 is an example of a lexical item or word stored in the actual sequence it appears in the sentence.

Referring next to FIG. 6a, in some embodiments, the reasoning process flow begins with a step for receiving input 601 including meta-knowledge and related historical case data. This step comprises creating a “session state” in cache and RAM or STM 113 that will persist until the causal analysis or interpretation is complete, then will be logged for future reference before the session state is purged from the volatile memory. The prerequisites for the process to be successful include a training data set 602, a pre-established knowledge base in graph structure 121, a validation data set 607.

The training data set is used to prime the system with selected knowledge propositions based on context information provided by the user prior to presenting the text to interpret or the case data for causal reasoning, according to some embodiments. The knowledge base 121 is the complete set of known knowledge propositions 206 stored in permanent non-volatile storage or LTM 115, and only a small portion of the knowledge is searched and used to process the input, according to some embodiments. The validation data set 607 includes a list of named sources 151 and 153 to search to corroborate or refute the solution, according to some embodiments.

In some embodiments, when case data or text to interpret is presented to the system, the system classifies the input 603 along with any historical data 602 presented by the user to support the reasoning or interpretation process. Classification generally means populating attributes 514 in specialized processing areas 511 in STM 113 based on a natural language interpretation process. Bi-directional causal reasoning 604 involves searching the knowledge graph 121 in LTM 115 for salient knowledge propositions 206, classifying them in the same specialized processing 511 areas in STM 113 based on the R objects in each proposition 206, and invoking the heuristics 508 associated with each populated attribute 514, according to some embodiments.

For both prospective and retrospective causal reasoning, the inputs include the model 121, the case data 601 tagged or positionally associated with model elements, and domain-specific rules to create causal predispositions, according to some embodiments. “Priming” information is treated as predispositions because the inputs, outputs and processes all use fuzzy logic thus the system delivers likelihoods rather than certainties and inferences rather than hard facts, according to some embodiments. Knowledge domains sometimes have inherent uncertainties, and some embodiments derive best-guess verdicts or predictions and build explanations that quantify the uncertainty as accurately as possible.

If there are any required attributes 514, in other words attributes 514 needed for a solution that are not populated, additional knowledge is sought for those attributes in the knowledge graph 121, according to some embodiments. Causal reasoning is bi-directional 604 because it attempts to discover both outcomes and causal factors not in the input. The fitness algorithm and heuristics 508 cause the fittest knowledge propositions 206 representing both causes (verdict) and outcomes (predictions) to emerge as the most likely. These are submitted to the user with explanation of the causal lineage 605 describing the causal path(s) 331 and the outcome(s) 336 that are associated with each other. When the knowledge of a causal relationship was acquired from a specific digital asset 151/153, bibliographic reference to the asset and access information such as web URL or network file system location will be provided the user for further research or validation. The reason there may be more than one possible solution is that many domains have co-occurrences, such as comorbidities in health diagnosis and multiple cascading constraints and outcomes in weather forecasting.

In some embodiments, the draft verdict 605 maybe validated 606 using a validation data set 607 consisting of information contained in public 151 and private 153 digital assets. Whether or not it can be validated, it can be delivered 608 to a user. Any new knowledge acquired during the reasoning or validation process may be added to the knowledge graph 609 to improve the quality and speed of future reasoning.

A significant challenge to working with an expansive knowledge model is maintaining a process within boundaries that will not lead to a combinatorial explosion of possibilities, most of which are too low in probability to be worth the processing cost to consider. In some embodiments, the AKM interpreter procedure of creating specialized dimensions in STM 113 effectively breaks the problem up into its logical subdivisions permitting components of the solution to be calculated independently, and later merged with the other solution components. Each attribute 514 of each specialized dimension 511 is used to resolve a multivariate marginal likelihood from which the multinomial truth values constituting the end solution can be assembled when the system finishes analysis for a given sentence or input case, according to some embodiments.

The model-based automated approach to inferring causality does not deal with absolutes but with likelihoods. Using weighted models can help in differentiating the relevance of possible causal factors in the final outcome. This approach is not intended for use in analyzing human intent as an element in causality: “She decided to do it, and the outcome was assured.” While human intentionality is an important aspect of natural language understanding of causality, it is not as amenable to prospective or retrospective causal reasoning.

The model and the structure of mechanism pairings with objects in the ontology axiomatize the knowledge for efficient processing. In some embodiments, rules and heuristics 508, for example mereological, temporal, spatial and taxonomical reasoning, interoperate in the causal reasoning to deliver more robust predictions and verdicts. Axiomatization further enables a single model to support multiple types of causal reasoning, according to some embodiments.

Types of causality include probabilistic, counterfactual, regularity, dispositional and agency forms of causality, according to some embodiments. In some embodiments, within a phenomenon, a candidate 516 is causally connected only if a change to the candidate 516 affects the outcome. When the system cannot confirm or refute the verdict, expert input bridges the gap. In some instances, identifying incorrect verdicts is difficult without human curation of the model, adding constraints that identify counter correlated factors that do not contribute to the outcome.

The respective roles of human curators and automated inference are shown in FIG. 6b, according to some embodiments. Ingested data 601 describes the input set described earlier in FIG. 6a. Assembling the input is usually mostly manual, but can be augmented with bots 150 to search for case history data for the case input and similar cases for training data sets 602. ML algorithms 616 ingest or read the case history data 601 and automatically compare it to previously learned cases. Differences between the cases are noted, and if the ML discovers knowledge propositions 206, causal factors 332 or outcomes 336 in the case data that do not coincide with knowledge propositions 206 already in the knowledge network 121, new propositions 206 and, if needed, new causal paths 331 are added as temporary knowledge 613 and presented to human curators 611 for validation.

Supervisors curate 611 a training data set 602 by identifying the historical cases that are closest to the case under consideration and defining why the cases are similar. The human curators 611 are subject matter experts and they also curate the validation data sets 607 and perform supervised learning tasks associated with the interpretation algorithms 612 and the causality inferences 613.

When preparing input, a data entry task asks the person submitting the case to describe the context and what is known and assumed about the case. This information becomes a set of selected concepts 614 that help prime STM 113 for the interpretation and causal reasoning processes. The hypothetical model 615 is the subset of the knowledge graph 121 that relates directly to the context and conceptual details of the case, including related causal paths 331. The AKM ML system 616 automatically infers, learns and validates knowledge as it is being processed, and once the case submitter and subject matter experts 611 review the verdict or predictions 617 and accept or decline them, AKM adjusts confidence values of key knowledge propositions 206 that contributed to the solution, according to some embodiments.

### Machine Learning

The weights in the knowledge network represent probabilities and the internal structure of each subgraph 206, and the links between objects represent probabilistic propositions, according to some embodiments. Thus, the knowledge network 121 is structured as a Bayesian network. As a Bayesian network, the knowledge network 121 is a multinomial distribution of up to millions of discreet elements, each complex in content and able to link with an arbitrary number of other elements. One element may be connected to one other element, or to 10,000. The link structure is, therefore, chaotic and unpredictable. Consequently, typical neural approaches, such as Boltzmann Machines and Hidden Markov Models, cannot be used with this model to deliver solutions through the typical training and processing functions of forward and backward propagation waves.

In some embodiments, using natural language interpretation and concept learning, however, the system adds to its knowledge and refines the confidence values 207 of individual knowledge propositions 206 as a result of processing new cases containing previously learned concepts, causal factors 332 and outcomes 336. The closer the cases are related, the more new cases contribute to understanding prior cases, especially when there are overlapping or intersecting causal paths 331. In this way, the system constantly learns and becomes better able to perform interpretation and causal reasoning functions, according to some embodiments. The more the system learns, the less human input is required to curate the inferences.

Referring next to FIG. 7a, human long-term memory is like a disk drive for storing facts and associations. The knowledge graph 121 is intended to resemble the structure, contents and functions of the human brain and LTM 115. STM 113 is also a part and function of the human brain and some embodiments model it in computers using volatile storage or Random Access Memory (RAM) 113 as a ready access storage area. During analysis and interpretation 701, small subsets of knowledge propositions 206 from LTM 115 are copied into STM 113 for efficient processing, according to some embodiments.

The working storage area or cache 114 has significant roles in supporting priming 702 and learning 616. Information from LTM 115 that may not be directly related to the case, but that shares a conceptual framework with elements of the case. The priming process 702 uses the selected concepts 614 described earlier. The selected concepts prime the network in a way similar to the brain function of constantly processing contextual cues from the five senses. These cues prepare the brain for new input. When humans encounter something completely out of context, it often creates confusion and is difficult to understand until enough context is gathered to make sense of it. In addition to storing the context that primes the knowledge processes, the cache is also used for learning as newly acquired knowledge propositions, and adjusted weights for existing knowledge propositions are stored in cache 114 until enough evidence is gathered to commit them to LTM 115, according to some embodiments.

Though this description distinguishes between pre-training, real-time analysis tasks and post-facto learning processes, much of the research in the field of cognitive modeling of neural processes treats the real-time adjustments of weights in STM 113 as “learning”. In some embodiments, the primary interpretation algorithms that allow correct interpretations to emerge are learning about the input. In some embodiments, the AKM interpreter system simply chooses to deliver the learned information as output and only remember things that are determined to be new information to the system.

In some embodiments, the working storage area 114 in the AKM interpreter is also a stateful holding place for parameters used in causal reasoning and for information that is expected to be useful in helping to interpret inputs. By retaining information that generally applies to a user and domain of work as user context, the AKM interpreter can better disambiguate words or phrases that have unique meanings in the user's situation. The collection of parameter and user context information is cached as propositions 206 organized in working memory 114 lists and matrices, according to some embodiments.

Objects in the cache may come from different sources:
User Preferences (elicited and inferred)
User Profile (elicited and inferred)
Discourse Context (inferred)
Operating Parameters (Preset, then possibly adjusted automatically)

The same emergent brain-like processes that support automated interpretation and causal reasoning, support learning, according to some embodiments. The term “emergent behavior” is applied to the human brain and other complex systems whose internal behavior involves non-deterministic functionality or is so complex, or involves the interaction of so many steps that tracing the through the application of multiple complex contextual constraints, genetic algorithms to assign, adjust and analyze the fitness of multiple candidates 516, attributes 514 and contexts 511, and threshold logic, according to some embodiments.

In some embodiments, the system is configured to activate emergent behavior by modifying the weight component of each confidence vector 517 of each candidate 516. In some embodiments, the starting value of the weight component is based on the knowledge proposition 206 weight 207 stored in the knowledge graph 121. In some embodiments, the value of the weight component 207 is increased each time a corroborating knowledge proposition 206 is processed and the value of the weight component 207 is decreased each time a refuting knowledge proposition 206 is processed.

Referring next to FIG. 7b, threshold logic in the AKM interpreter involves mathematical functions applied to vectors between a maximum value 711 and a minimum value 712 to determine if the magnitude of the vector is sufficient to merit attention, according to some embodiments. The threshold may be expressed as a single minimum threshold 713, or may have standard 714 and maximum threshold values 715. This logic conceptually places a bar below which the activation value is insufficient to emerge to consciousness and above which attention is drawn to the vector of a specific concept or candidate, according to some embodiments. This bar is expressed as a numerical value that is within range of the expected activation potential of vectors to which the threshold applies, according to some embodiments. Different thresholds may be applied to different vectors and the thresholds for a single vector or for multiple vectors may be adjusted during the course of processing, according to some embodiments.

In some embodiments, because thresholds are adjustable, the mathematical threshold function is a sigmoidal curve 716 over a candidate X 516 whose values are inspected over time as in the formula: f(Xt, f(Xt+1, f(Xt+2 . . . ) . . . ) . . . ).

Specialized dimension 511 containers are the fundamental structure in the AKM interpreter system that exhibit emergent behavior, according to some embodiments. The three types of vectors, dimension 511 or context, attribute 514 and candidate 517, each possess activation levels that represent the fitness of each dimension, attribute and candidate, according to some embodiments. The threshold factor 714 applicable to each of these determines whether the vector emerges to consciousness or not, according to some embodiments. At or above threshold magnitude 714, an object at any level is said to emerge or attract attention. Parameters in the system define how many emergent objects in each category are fit enough to survive, according to some embodiments.

Each dimension vector 513, attribute vector 515 and candidate element vector 517 has both a direction and a numeric level of activation, according to some embodiments. The distinct levels of activation are below threshold 717, at threshold 718 and above threshold 719. The directions are emerging 720, static 721 and falling 722.

Determining the emergence of candidates 516 in a single attribute 514 of a context dimension 511 in a specialized processing area can be compared to a children's game in which an object is hidden in a room and the person who hid the object guides the contestant to the object by telling them they are getting hotter or colder. The nearer they approach the object, the hotter they are, and the further they are, the colder. In some embodiments, in the AKM interpreter system, candidate 517, attribute 515 and dimension vectors 513 heat up and cool down. An automated interpreter agent searches through all hot dimensions for hot attributes, based on inputs from other concepts 731 in FIG. 7c, and selects hot candidates 516 (surviving genes) based on magnitude and rate of change, for resolutions to the meaning of the input, according to some embodiments.

In some embodiments, the system is configured to retrieve doping inputs 731 and priming inputs from a context associated heuristic algorithm and apply the respective doping inputs and priming inputs to applicable candidates 516 in applicable attributes 514 in applicable specialized processing areas 511.

Depending on the stage of the selection process at the time of emergence of any given object vector, the process can be different, according to some embodiments. In some embodiments, attention in the context of emergence is applied as the final interpretation of a part of input when emergence occurs at or near the end of the interpretation process. When emergence occurs earlier, it can trigger additional processes such as spawning a new wave of activation in LTM 115, in STM 113 or both. The new wave of activation has the potential to increase and/or decrease the magnitude of any vector, including the vector object that spawned the wave, thus potentially forcing it below threshold and deselecting it, according to some embodiments.

In some embodiments, the system is configured to modify a candidate confidence vector 517 of each candidate 516 in each specialized processing area 511 based on frequency of matching between a respective candidate 516 and at least one of: (i) a respective user input, doping input and priming input, and (ii) knowledge propositions 206 encoded in at least one subgraph, to bring about emergent behavior by incrementing or decrementing a weighting component 207 of the candidate confidence vector 517.

In some embodiments, candidate 516 selection is based on aggregate activation generated through neural processes in the portion of the knowledge network 121 in STM 113 (shown in FIG. 7c). This process 732 applied to each individual candidate 516 is probabilistic in that the emergence of winning or surviving candidates 516 arises from analyzing the Bayesian probability that this proposition applies to the current input, according to some embodiments. In other words, each increment of positive 733 and negative activation 734 applied to each candidate 516 respectively 738 increases and decreases the probability that the recipient candidate 516 will emerge, according to some embodiments. Hence, each increment of activation bolsters or weakens the probability that the recipient proposition will be found true and applicable to solving the problem needed to resolve the case or meaning of the input 731, according to some embodiments.

In some embodiments, the system is configured to extract emergent candidates 516 from each specialized processing area 511 with a largest value of the weighting component of the candidate confidence vector 739.

The combination of the direction and magnitude of activation of each element in each vector 517 constitutes its state, according to some embodiments. There are nine possible states for each element as shown in FIG. 7b. Activation can also be implemented as two states: 1) below threshold and 2) at or above threshold or “fired”. Both the direction and activation can be calculated from the vector weight 517, the previous vector weight 517, and new activation flow potentials. The original vector weight 517 and other constraints can be combined to make the state more expressive or richer, enabling more complex reasoning.

In some embodiments, the algorithms used to select emergent 719/720 candidates 516 is characterized as a genetic algorithm (FIG. 7d). They are based on a genetic principle suggesting that in a gene pool, only the fittest organisms survive or “survival of the fittest”. Because the subject of this algorithm is digital information, no deaths are involved. The premise is that each potential solution component is treated as a candidate 516 and fitness algorithms 743 are used to select winners 745 and survivors 746. Each attribute 516 in Each specialized processing area 511 may use a genetic algorithm to select the winning candidate knowledge propositions 206 for that attribute 516.

Because language is ambiguous and many sentences or phrases may have multiple interpretations, intended or otherwise, fitness algorithms for this process are ideal because they can result in multiple survivors that may correspond to multiple meanings for a single input.

Referring to FIG. 7e AKM deep language understanding uses shallow language information from spelling 751, phonology 752 and morphology 753 to help classify input. Grammar or syntax 754 helps identify the structure of words, phrases and sentences, but not the meaning. The fitness algorithms described herein are best suited for resolving constraints at the deeper levels of language: semantics 755, pragmatics 756 (including resolving deixis and anaphora) and context 757 (including resolving logic possibility and impossibility).

In some embodiments, the system is configured to detect gaps by determining whether any attribute 514 of any specialized processing area 511 is required for a solution that has no candidates 516 and in response to determining that a respective attribute has no candidates, performing further search of the knowledge graph 121 for possible candidates.

In some embodiments, the stochastic processes that determine and adjust the fitness of each candidate 516, attribute 514 and specialized dimension 511 in the AKM interpreter operate at the object level. This is necessary because resolution of ambiguity must successfully find the correct meaning or meanings for each symbol, word and phrase. This is possible because every specialized dimension 511, attribute 514 and candidate 516 possesses direct ties to knowledge in the knowledge network 121 both at the object and proposition 206 levels. The rise and fall of object vectors 517 is the primary mechanism of genetic selection.

In some embodiments, from a propositional logic perspective, the fitness of a candidate 516 is determined from the truth values of the objects at the proposition level. But unlike typical methods for mapping truth values such as Venn diagrams or truth tables, the AKM interpreter uses excitatory and inhibitory values that are derived from multiple successive activation wave processes, according to some embodiments. Doping modifies the behavior of an activation wave according to some embodiments. The starting value of a vector's node comes directly from the knowledge network 121, but that value may rise or fall based on the frequency of encountering supporting and contradictory propositions 206 extracted from the knowledge network 121 to STM 113, according to some embodiments.

In some embodiments, doping introduces quasi-random variables after the first activation wave has propagated through all the specialized processing areas 511. In some embodiments, a genetic mutation process alters the characteristics of a solution candidate 516 or path 331 during the course of processing. The mutated result can then compete with other results for emerging fitness as a solution.

The common use of weights in fuzzy logic or stochastic processes is appropriate as a measure of activation at the object level, therefore the weight 207 of an object reference to a candidate 516, attribute 514 or specialized dimension 511 constitutes the level of activation or magnitude of its vector 517. In some embodiments, this activation level or magnitude is used as the fitness for the genetic scoring processes. As such, unlike the weightings in typical neural networks that result in single “winner-take-all” results, the fitness values can result in multiple successful results, thus enabling interpretation of multiple meanings which may be present in text whether intended or unintended by the speaker or author of the text.

In some embodiments, the system is configured to infer the solution of unknown outcome and/or unknown causes based on emergent candidates 516 for each attribute 514 of the specialized processing areas 511.

### Building the Model

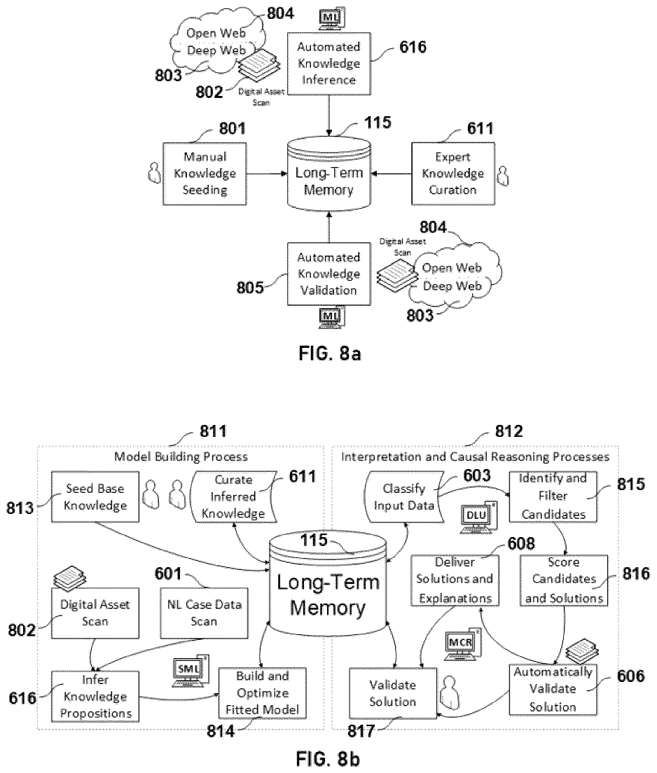

As with humans and many AI systems, AKM capabilities grow more accurate and broader over time, according to some embodiments. Referring next to FIG. 8a, the foundational causal knowledge is explicitly seeded in the knowledge graph 121 by human knowledge engineers 802, according to some embodiments. In some embodiments, there are automated components and machine learning techniques 616 that make this process efficient, but much of the work is performed by human subject matter experts and AI technicians 802. In lieu of manual seeding 801, automated seeding processes may be used to scan linked open data and digital assets 151/153 and 802 located in deep web subscription sites 803 and open web free sites 804 based on very specific, and relatively narrowly defined search criteria to build on manually created knowledge propositions 206, according to some embodiments.

In some embodiments, models are populated using supervised concept learning 611, where causal knowledge is inferred from source inputs and combined with seeded concepts. This repeats the process shown in 801 or 616 through 805, but on a much broader basis, giving the system the ability to follow new web links to expand the search to concepts not explicitly defined by the human knowledge engineers. Seeded concepts are predefined factors and causal chains that serve as templates for machine learning procedures 803, including Bayes classification algorithms, simplified genetic algorithms and path heuristics. Bayes classifiers are used to weight the model by calculating posterior probability from the class and predictor of prior probability: P(c|x)=P(x1|c)×P(x2|c)× . . . ×P(xn|c)×P(c).

Simplified genetic algorithms are used to discriminate, rank and validate possible candidate 516 determinants in retrospective and prospective causal models, according to some embodiments.

In the initial phase of training the continuous learning knowledge graph 121, as the network is acquiring baseline knowledge, the testing and refining processes are more manual 611 than automated 807, but the model is structured as a Bayesian Network, so it lends itself to automated concept testing and validation 808 as extensions of the core learning algorithms and heuristics, according to some embodiments. The automated knowledge validation processes scan linked open data and digital assets 151/153 and 608 located in deep web 803 subscription sites and open web 804 free sites based on the specific elements in the solution or newly acquired knowledge propositions 206 in working memory, according to some embodiments.

In some embodiments, the model is completely distributed. In some embodiments, the model grows arbitrarily without impairing reasoning processes and outcomes. Some embodiments use a curated model (e.g., with unconstrained growth).

Referring next to FIG. 8b, in some embodiments, the components and processes of building the model 811 and of using the model to support interpretation and causal reasoning 812 are similar. In some embodiments, the seeding process 813, while much more complex and time-consuming, is analogous to the manual portions of input preparation process described above in reference to FIG. 6b. In some embodiments, knowledge curation 611 occurs in both building the model and improving it. In some embodiments, the knowledge graph 121 in LTM 115 serves as the central knowledge store for both.

Some embodiments scan digital assets 151/153 to learn at both the model building 802 phase and solution validation 606. NL case data scanning 601 is used in the context of input for causal reasoning, as well as in the a-priori learning process to build causal knowledge and hypothetical models. In some embodiments, the algorithms and heuristics used to infer new knowledge propositions 616 use the existing knowledge graph 121 to avoid duplicating existing knowledge and attempt to connect new knowledge with existing knowledge through matching Y 202 or C objects 201. Some embodiments use synonym matching, similarity heuristics or morphological analysis when the words do not match exactly.

Some embodiments use advanced heuristics for fitting new knowledge to the model and optimizing fitted hypothetical models 814. Fitting is a way of differentiating binary from non-binary factors, and using heuristic mechanisms and rules to quantify the impact of non-binary factors to show the degree to which that factor influences the outcome. As an example of a binary factor: the automobile's “alternator is functional”. This proposition can be true or not. If not, the battery is predicted to die after a certain number of miles driven.

A non-binary factor is the “number of miles driven before the battery will die”. With these two factors, if the alternator is not functional and distance to the destination is greater than the number of miles driven before the battery will die, the system accurately predicts that the car will not be able to arrive at the destination under its own power and that the alternator will need to be replaced or the battery will need to be externally recharged or replaced before the next journey, according to some embodiments.

In some embodiments, AKM supports an ever-growing list of heuristics, and each can be tied to either an R object 203, a C object 201 or a Q object 205 in any knowledge proposition 206.

The processes of classifying input data 603 to identify and filter candidates 516 so that they can be scored 816 using emergence algorithms and heuristics are described above, according to some embodiments.

In some embodiments, automated validation processes 606 as described earlier, precede delivery of solutions and explanations 608 and work in conjunction with manual validation 817, similar to the processes of curation 611 and “supervised learning” 613.

### Explanation Utilities

AI has long been characterized by “Explanation Utilities” that explain the reasoning process that led to the conclusion or verdict presented 608. In the domain of human health, the ability to explain both the causal relationships and the mechanisms of causation are critical to supporting highly trained medical professionals in their diagnostic work.

In some embodiments, the AKM system uses both inference rules and causal modeling to derive solutions. It uses strong mechanistic causal models 331 to describe causal links between factors and outcomes, and rules in conjunction with heuristics to filter 815, score 816 and select candidates 516, constituting the core of causal reasoning. The system uses a more detailed and granular knowledge base and a more flexible set of heuristics inference options than are available elsewhere, according to some embodiments.

In some embodiments, much of the process is embedded in the knowledge fabric 121 and 124, and the explanation utility's 605 ability to reconstruct the lineage of the causal reasoning makes it easy for people of varying levels of technical knowledge to understand the bases for solutions delivered 608. AKM builds an explanation based on the emergent set of knowledge propositions 206 in specialized processing areas 511.

Because each knowledge proposition 206 can be articulated as an English language sentence, the collection of the emergent propositions serves as the explanation, especially when causal propositions from the hypothetical model 121 are chained 311 to show the progress from root cause to final outcome, according to some embodiments.

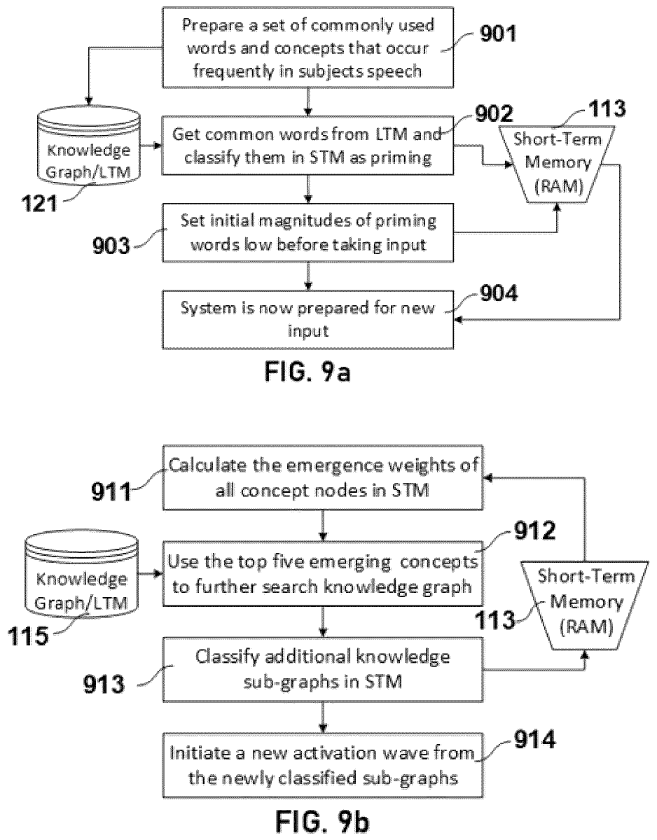

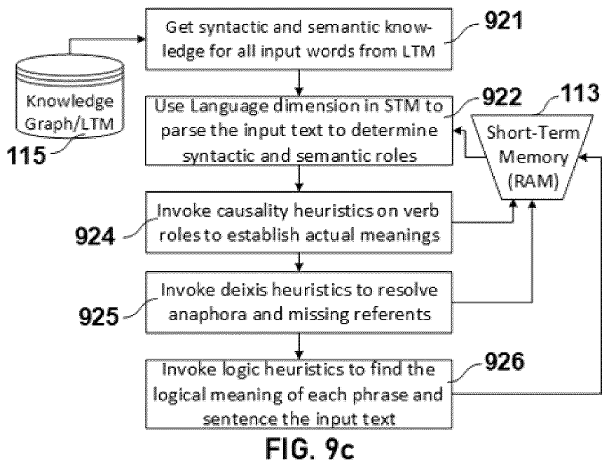

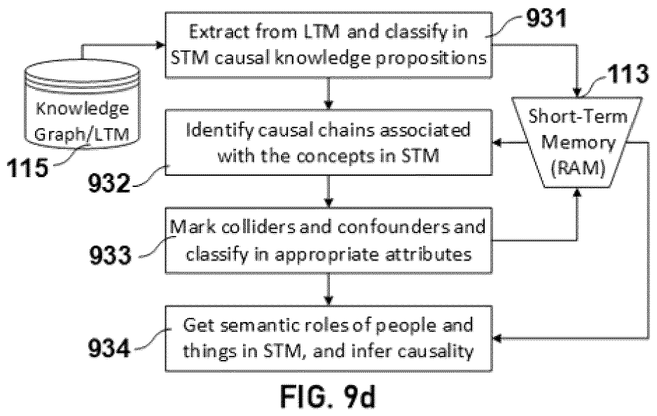

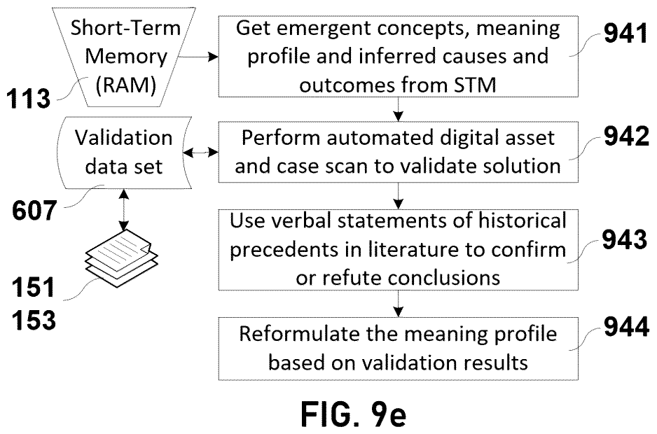

FIG. 9a shows an example logical flow of a priming heuristic, according to some embodiments. In some embodiments, prior to input processing expectations are established by preloading a set of commonly used words 901. Commonality is defined broadly in terms of frequency of occurrence in the user's language, according to some embodiments.

Commonality is also defined narrowly in terms of historical user inputs, according to some embodiments. As illustrated, common words are stored 901 in the knowledge graph 121 and loaded 902 in STM 113 at the start of a user session in which input is processed. The initial magnitudes for frequent words 903 in the user's language are set very low, for example at half the confidence value of average a-priori magnitude of propositions 206 in the knowledge graph 121 and confidence values for frequent words in user's prior inputs are set medium low, for example at three fourths the confidence value of average a-priori magnitude of propositions 206 in the knowledge graph 121. Once priming is complete, the system is ready for input 904.

FIG. 9b shows an example logical flow of a doping heuristic, according to some embodiments. In some embodiments, early in the processing and emergence of concept nodes 911 in STM 113, i.e. prior to the completion of language, causality and/or validation heuristics, additional related concepts are searched and retrieved 912 from the LTM 121 (sometimes called the knowledge graph 121), classified in STM based on classification procedures 913, then used as a starting point for an activation wave 914 to activate emergent behavior in a way that is only indirectly related to the input.

FIG. 9c shows an example logical flow of a sequence of language heuristics, according to some embodiments. In some embodiments, each stratum of language from syntax and semantics 921, to deixis 925, and to logical intent 926, are resolved using knowledge propositions 206 from the knowledge graph 121 or LTM 115, classified in special processing areas or dimensions 511 in STM 113.

In some embodiments, language related concepts are searched and retrieved from the knowledge network 121, classified in STM 113, then combined with causality heuristics 924 to resolve possible ambiguity in each language stratum and determine the intent of the user. Some embodiments use time, space, taxonomy, meronomy, identity and commerce heuristics, for interpretation of intent. In some embodiments, syntax roles include parts of speech, such as noun, verb, adjective and pronoun. Semantic roles include agent, action, instrument and object and reflect specific roles that persons and things perform vis-à-vis the action or verb associated with causality, according to some embodiments.

FIG. 9d shows an example logical process flow of a causality heuristic, according to some embodiments. In some embodiments, an extractor 931 uses advanced matching algorithms to identify and extract causal knowledge propositions 206 from a knowledge graph 115/121 and classifies them in STM 113. The classification process forms multiple tentative causal chains and each is tied to concepts from the input 932 in the STM Word List and other STM structures.

Based on the specific relationships contained in the knowledge propositions 206, some causal factors or elements in causal chains 331 can be marked as probable colliders or confounders 933. Coordination with the semantic interpretation process 934 then identifies the action, its agent(s), any instrument(s) or mechanism(s) likely to contribute to the outcome, the object(s) of the action and the likely outcome(s), according to some embodiments.

Prior to invoking validation heuristics, additional heuristics associated with special processing areas 511 or specific R 203, C 204 or Q 205 values may be applied to the candidates 516 in specific attributes 514 and/or context dimensions 511. As examples: temporal heuristics may be applied to attributes in the time dimension to infer the time the event described in the input occurred, or its beginning, ending or duration; spatial heuristics may be applied to attributes in the space dimension to infer the location, origin, destination or distance of the events in the input; taxonomical inheritance heuristics may be applied to candidates in the taxonomy dimension to infer characteristics of parent objects that may be applicable to child objects in ways that may affect the outcome.

FIG. 9e shows an example logical process flow of a validation heuristic, according to some embodiments. The validation heuristic tests the emergent results 941 interpretation in STM 113 by getting the result set and using the key concepts as a basis for a digital asset scan 942 that uses a pre-existing validation set 607 based on relevant digital assets 151/153 or seeks to create a new validation set if none is available by searching online information about the concepts under consideration. The verbal statements about historical causes and outcomes matching the concepts in STM 113 are linguistically and logically compared to see if they support the conclusions or not 943, and if not, the conclusions may be reformulated 944 based on the validation data set, according to some embodiments. In some embodiments, the meaning profile includes answering one or more questions to represent the intent of the input.

For example, the questions may include the following: Is the sentence declarative, interrogative, imperative or exclamatory? Who did what to whom, where, when and with what instrument(s)? Why did the described action occur and why is it important? What is described and is the description consistent with common presuppositions?

A concept learning heuristic may use preformulated sentence structures as a basis for inferring new knowledge propositions from text content on web pages. As an example, if mined web data on a page describing types of glass for construction professionals contains the sentence “Coated glass is highly durable and performs well in harsh weather conditions”, the concept learning heuristic may infer the knowledge proposition: (X) 201 “coated glass” (R) 203 “type” (Y) 202 “glass” (C) 204 “construction” (Q) 205 “highly durable”. This knowledge proposition can be read “Coated glass is a type of glass in the context of construction that is highly durable”. A similar knowledge proposition may be inferred from the same input with X 201, R 203, Y 202 and C 204 being identical and the Q reading “performs well in harsh weather”.

### Example Systems and Methods of Mechanistic Causal Reasoning

According to some embodiments, a method is provided for mechanistic causal reasoning using techniques described above. The method is performed by a system (e.g., the system shown in FIG. 1b) that includes one or more memory units (e.g., the memory 113, 114, and/or 115) each operable to store at least one program, and at least one processor (e.g., the processor 111) communicatively coupled to the one or more memory units, in which the at least one program, when executed by the at least one processor, causes the at least one processor to perform steps of the method.

The method includes receiving input data from a user (e.g., input obtained using any of the devices 117, . . . , 120). The input data describes a request or a case and known background information about the case (as described above in reference to FIG. 1a). The case is a set of causes and/or outcomes. The information about the case lacks sufficient information about why a known outcome occurred or what outcome will occur as a result of known causal factors.

The method includes determining whether the user intends to generate a predicted outcome from known causes or generate predicted causes from a known outcome (as described above in reference to FIG. 1c). Forward reasoning that maps known causes to inferred outcomes, or reverse reasoning that maps known outcomes to inferred causal factors, are based on a knowledge graph (as described above in reference to FIG. 1c) with subgraphs 206. At least one subgraph 206 is linked to another subgraph 206 by sharing a common lexical item 123. Each of the subgraphs represent a knowledge proposition 206 including: a subject component 201 (e.g., the subject component 211 in FIG. 2b), an associate component 202, a named relationship component 203 that links the subject component 201 and the associate component 202, a context component 204 that identifies a domain of knowledge that an association is true, a qualifier component 205 that describes a constraint governing the relationship that further narrows the context in which the association is true, a weight component 207 that is a probability factor of a likelihood that the proposition that the subject component 201 is related to the associate component 202 in the context identified by the context component 204, and a mechanism component 219 that describes an action that the subject component is performing or mechanism used to affect the associate component.

The method includes traversing the knowledge graph 121 stored in LTM 115. Traversing the knowledge graph 121 includes associating each word of the input with a lexicon object 124, and associating each lexicon object 124 with a plurality of propositions 206 in the knowledge graph 121. Each proposition corresponds to a subgraph 206, and the propositions define a relationship between the subject component 201 and the associate component 202 in the subgraph 206. Traversing the knowledge graph 121 also includes classifying (e.g., as described above in reference to FIGS. 5b and 6a) the input and associated knowledge propositions 206 into named attributes 514 of named specialized processing areas 511 in STM 113 based on named relationships in propositions 206.

Each specialized processing area 511 represents a contextual component of a solution. Each attribute 514 in each specialized processing area 511 represents a characteristic associated with a concept defining a respective specialized processing area 511. According to some embodiments, a candidate 516 is a potential component of an unknown outcome and/or unknown cause associated with the named attribute 514. Each candidate 516 is associated with a modifiable confidence vector 517 including a weight component and an emergence flag 518.

Processing by a specialized processing area 511 includes: (i) activating emergent behavior (e.g., as described above in reference to FIG. 7b) by modifying the weight component 207 of each confidence vector 518 of each candidate 516. A starting value of the weight component 517 is based on the knowledge proposition 206 weight stored in the knowledge graph 121.

The value of the weight component 207 is increased each time a corroborating knowledge proposition 206 is processed, and the value of the weight component 207 is decreased each time a refuting knowledge proposition 206 is processed; (ii) retrieving doping inputs and priming inputs (e.g., the inputs 731 described above in reference to FIG. 7c) from a context associated heuristic algorithm (e.g., as described above in reference to FIGS. 9a and 9b) that generates respective doping inputs and priming inputs for each candidate 516 in each attribute 514 in each specialized processing area 511, and applying the respective doping inputs and priming inputs to each candidate 516 in each attribute 514 in each specialized processing area 511; and (iii) modifying a candidate confidence vector 517 of each candidate 516 in each specialized processing area 511 based on frequency of matching between a respective candidate 516 and at least one of: (i) a respective user input, doping input and priming input, and (ii) knowledge propositions 206 encoded in at least one subgraph, to bring about emergent behavior by incrementing or decrementing a weighting component 517 of the candidate confidence vector.

Traversing the knowledge graph also includes extracting emergent candidates from each specialized processing area 511 with a largest value of the weighting component 517 of the candidate confidence vector. In some embodiments, traversing the knowledge graph 121 also includes detecting gaps by determining whether any attribute 514 of any specialized processing area 511 is required for a solution (e.g., the solution in FIG. 5c) that has no candidates 514 and in response to determining that a respective attribute 514 has no candidates 516, performing further search of the knowledge graph 121 for possible candidates 516. Traversing the knowledge graph 121 also includes generating (as described above) a solution of unknown outcome and/or unknown causes based on emergent 718 or 719 candidates 516 for each attribute 514 of the specialized processing areas 511.

In some embodiments, the system further includes: a storage architecture (e.g., the memories 113 or 114) configured to include temporary special processing area 511 structures used to classify and organize the input data from a user by named category, including a plurality of context dimensions (e.g., the dimensions 502, 503, . . . , 507 in FIG. 5a, the dotted line structure includes dimensions 511 in short term memory 113, also as described above in reference to FIG. 5b) as ordered multi-dimensional storage structures 511. Each context dimension 511 includes a named context header (e.g., the header 512), one or more attribute dimensions (e.g., the attribute dimensions 514). Each attribute dimension represents a subject component 514, and each attribute dimension is associated with a respective candidate 516 dimension. One or more attribute dimensions is associated with a respective context dimension 511. Each attribute dimension 514 contains a name representing a specific concept applicable to the named context header 512 of said associated context dimension 511. At least one candidate dimension 516 contains zero or more knowledge propositions 206, for each named attribute object 514 in said attribute dimension.

In some embodiments, at least one multi-dimensional structure (e.g., the structure shown 511 in FIG. 5a) is specialized in causality, when more than one causal candidate 516 exists in an attribute 514, said causal candidates are ordered to represent a causal path 311 of predecessor and successor knowledge propositions that form causal factors 332. In some embodiments, in any given multi-dimensional structure specialized in taxonomy, when more than one candidate 516 exists in an attribute 514, said candidates 516 are ordered to represent a hierarchical or taxonomical ordering scheme of super-ordinate and subordinate classes of objects.

In some embodiments, in any given multi-dimensional structure 511 specialized in space and time, when more than one candidate 516 exists in an attribute 514, said candidates 514 are ordered to represent a spatial or temporal ordering scheme of location and time classes of objects. In some embodiments, in any given multi-dimensional structure 511 specialized in meronomy, when more than one candidate 516 exists in an attribute 514, said candidates 516 are ordered to represent a part whole constructive ordering scheme of part and whole classes of objects. In some embodiments, each attribute dimension 514 is defined as either required or optional for solution generation.

In some embodiments, each said candidate 516 is associated with a vector 517 comprised of magnitude and direction components, constituting an adjustable score for each said candidate 516. In some embodiments, candidate object 516 related information further includes an original magnitude and emergence flag (e.g., the flags 534 shown in FIG. 5d) for each candidate 516.

In some embodiments, the method further includes steps for analysis of meaning of an ordered group of input text objects (e.g., input text is tokenized, each token constitutes ordered group, and each token is an object; as also described above in reference to FIG. 5f; sometimes referred to as lexical items 124) forming natural language phrases and sentences based on a scoring strategy. The steps include segregating (or separating) individual words in the input text, adding them to a word list 541 in a short-term memory (STM) 113, searching for each input word in a lexicon 124 having a plurality of words therein. Each said word is linked to a plurality of knowledge propositions 206. In some embodiments, the steps also include analyzing morphology of said words by determining if a prefix or suffix has been added to a root word to form said input word and adding root words to the word list 541.

In some embodiments, the steps also include extracting, from the knowledge graph 121, said knowledge propositions 206 formed, in part, by each word in the word list 541. In some embodiments, the word list 541 is expanded to include additional words when extracted propositions 206 contain X 201, Y 202, C 204, or Q 205 objects not yet in the word list 541. In some embodiments, extracting includes using lexical items 124 or tokens from the input and related information to search the knowledge network 121 for knowledge propositions 206 in which the lexical item 124 matches the X 201, Y 202, C 204, or Q 205 object in any knowledge propositions 206, then returning those knowledge propositions 206 to STM 113 for classification.

In some embodiments, the steps also include classifying a plurality of candidates 516 formed of directed subgraphs 206, each said candidate 516 describing an explicit logical relationship between one object and another object, into a specialized processing area 511. In some embodiments, the steps also include comparing a first or X object 201 of each candidate 516 to find matching objects in STM 113 and adjusting the vector 517 of each candidate 516 based on the quantity of matching objects.

In some embodiments, the steps also include comparing a second or Y object 202 of each candidate 516 to find matching objects in STM 113 and adjusting the vector 517 of each candidate 516 based on the quantity of matching objects. The steps also include comparing a third or C object 204 of each candidate 516 to find matching objects in STM 113 and adjusting the vector 517 of each candidate based on the quantity of matching objects. In some embodiments, comparing includes matching the lexical items 124 or tokens from the input with lexical items 124 that exactly or closely match the X 201, Y 202, C 204, or Q 205 object in any knowledge proposition 206.

In some embodiments, the steps also include invoking and executing interpretation heuristics 508 associated with the named relationship 203 or R values of the candidates 516 with the highest score vectors 517 to further reorder 744 in FIG. 7d concepts in each attribute dimension 514 of each specialized processing area 511 based on fitness.

In some embodiments, the steps also include adjusting the score vector 517 assigned to affected candidates 516 based on a quantity of recurring objects or a frequency of encountering recurring objects during heuristic 508 processes. In some embodiments, adjusting includes changing the numerical value of the score vector 517 or confidence value associated with a given concept of knowledge proposition 206. Corroborating indicators adjust the score upward representing a higher confidence that this is a correct understanding of the concept or knowledge proposition 206 in the case of the given input, while refuting indicators adjust the score downward representing a lower confidence that this is a correct understanding of the concept or knowledge proposition 206 in the case of the given input. The aggregate influence of all the corroborating and refuting indicators constitute the final confidence value 517 applied to each concept and knowledge proposition 206 in STM 113.

In some embodiments, the steps also include reordering 744 in FIG. 7d said candidates 516 based on the direction and magnitude of said vectors 517, wherein said vector directions comprise emerging 720, static 721, and falling 722 conditions. Said vector magnitudes include numeric values, when compared with a numeric threshold 714 value, are determined to be above threshold 719, at threshold 718, or below threshold 717 value. In some embodiments, the steps also include determining the context of the of the input text based on the highest scored C object 204 in the appropriate specialized processing areas 511. In some embodiments, the steps also include invoking and executing additional heuristics 508 to find candidates 516 for any required attributes 514 with no candidates 516, and if found, repeating the above steps of segregating, analyzing, extracting, classifying, comparing, adjusting, reordering, determining, invoking and executing additional heuristics steps. In some embodiments, the steps also include applying a fitness algorithm to determine the fittest candidates of those compared in each attribute dimension 514 of each specialized processing area 511. In some embodiments, the steps also include formulating a meaning profile based on the highest scoring or fittest emergent candidate 516 of each attribute dimension 514 of each specialized processing area 511.

In some embodiments, the method further includes steps for performing deep natural language understanding. The steps include receiving input text, formed of a plurality of words, and matching each word with a word in the lexicon 124 to populate an ordered word list 541. In some embodiments, the steps also include extracting phrases (e.g., as described above) including idioms in the lexicon 124 in which one or more words in the input appear in the phrase, and adding such phrases to said word list 541. In some embodiments, the steps also include using punctuation and other linguistic cues to segregate each sentence in the input to store each input sentence into an ordered sentence matrix (FIG. 5f).

In some embodiments, the steps also include extracting, from the knowledge graph 121, propositions 206 formed, in part, by each word in the word list 541. In some embodiments, the steps also include classifying 603 said extracted propositions in the specialized processing areas based on an applicable attribute 514 of a respective specialized processing area 511. In some embodiments, the steps also include applying the fitness algorithms to determine the fittest propositions 206 of those compared. In some embodiments, the steps also include invoking natural language understanding heuristics 508 to interpret the context and relationships of said words, phrases and sentences by analyzing each level of linguistic content (FIG. 7e) of said data objects, wherein the levels include pragmatics 756, context 757, semantics 755, grammar or syntax 754, morphology 753, phonology 752, spelling 751 and prosody.

In some embodiments, the method includes steps for the analysis of the causality based on a scoring strategy of an ordered group of input text objects forming natural language words and phrases classified into a specialized processing area 511 for causality fitness 743 processing representing causal factors or outcomes. In some embodiments, the steps include providing a plurality of candidates 516 formed of directed subgraphs 206, each said candidate 516 describing an explicit causal relationship between one object and another object. In some embodiments, the steps also include comparing a first or X object 201 of each candidate to find matching objects in STM 113 and adjusting the vector 517 of each candidate 516 based on the quantity of matching objects. In some embodiments, the steps also include comparing a second or Y object 202 of each candidate 516 to find matching objects in STM 113 and adjusting the vector 517 of each candidate 516 based on the quantity of matching objects.

In some embodiments, the steps also include comparing a third or C 204 object of each candidate 516 to find matching objects in STM 113 and adjusting the vector 517 of each candidate 516 based on the quantity of matching objects. In some embodiments, the steps also include invoking and executing causality heuristics 508 (932 in FIG. 9d) associated with the named relationship or R 203 values of the candidates 516 with the highest score vectors 517 to further reorder 744 concepts in the attributes dimension 514 of each specialized processing area 511. In some embodiments, the steps also include adjusting the score vector 517 assigned to affected candidates 516 based on the quantity of common objects or the frequency of encountering common objects during heuristic processes.

In some embodiments, the steps also include reordering 744 said candidates 516 based on the direction and magnitude of said vectors 517, wherein said vector directions comprise emerging 720, static 721, and falling 722 conditions. Said vector magnitudes 517 comprise numeric values, when compared with a numeric threshold value 714, are determined to be above threshold 719 or emergent, at threshold 718, or below threshold 717 value. In some embodiments, the steps also include determining the context of the of the input text based on the highest scored or fittest emergent C object 201 in the appropriate specialized processing areas 206. In some embodiments, the steps also include invoking and executing additional heuristics 508 (see examples described above) to find candidates 516 for any required attributes 514 with no candidates 516, and if found, repeating the steps of providing, comparing the first or X object 201, comparing the second or Y object 202, comparing the third or C object 204, invoking and executing, adjusting the score vector 517, reordering 744, determining the context, and invoking and executing the additional heuristics 508. In some embodiments, the steps also include invoking and executing causality heuristics 508 (932 in FIG. 9d) to create contiguous causal chains or paths that identify and order the most likely causal factors and outcomes for the input data set.

In some embodiments, the method further includes generating, filtering and scoring alternative candidates 516 for solutions including: (i) forward-looking solutions selecting and prioritizing predicted outcomes for known causal factors; (ii) reverse solutions selecting and prioritizing likely candidate 516 causal factors for known outcomes; (iii) heuristic algorithms 508 for applying forward-chaining inference rules to adjust the prioritization of solution candidates 516; (iv) heuristic algorithms 508 for applying backward-chaining inference rules to find candidates 516 in the input or the knowledge network 121 for required attribute dimensions 514 with no candidates 516; (v) rules within the heuristic algorithms 508 for differentiating binary and non-binary factors and applying weighting to each candidate 516 to show both the likelihood of the candidate 516 of forming part of a final solution and the degree to which emergent 720 candidates participate in the outcome; (vi) inheritance rules within the heuristic algorithms 508 for applying characteristics of higher-ordered taxonomical concepts to lower-ordered taxonomical concepts; and/or (vii) a human user interface 817 to display prioritized solutions, their weightings and explanations.

In some embodiments, the method further includes using a lineage tracking algorithm for generating explanations 608 based on the rules and causal path 311 that lead to the solution, and why other possible solutions were rejected.

In some embodiments, the method further includes automatically validating a solution 606 by searching digital assets 151/153 with an advanced causal natural language interpreter to find and analyze corroborating text stating that said solution is possible, common, unlikely or impossible, including: (i) searching and analyzing text in public web pages on the open web; (ii) searching and analyzing text in private deep web content sources with limited access controlled by membership; and/or (iii) searching and analyzing text in private case data in internal systems, documents and databases.

In some embodiments, the method further includes searching a plurality of named sources 153/151 for information to be used in the creation of new knowledge propositions 206 to build a knowledge graph 121 for use in causal reasoning and natural language understanding, and in the validation of inferred knowledge propositions 206 and solutions. Some embodiments include a knowledge graph 121 comprising a plurality of predefined seed concept nodes 206 (sometimes called seeded concept or seeded concept node; e.g., the node 813 described above in reference to FIG. 8b) connected by descriptive, taxonomical, meronomical, spatial, temporal, linguistic and/or other named relationship vertices, and a plurality of directed subgraphs 206 containing manually defined mechanistic cause and effect nodes connected by relation 203 vertices. Some embodiments include a search string constructor or formulator algorithm and user interface to search a plurality of named sources 153/151 for content matching the search string or logical components thereof. Some embodiments include a source list manager and user interface for selecting sources to search to support learning and validation.

Some embodiments include a discovery bot 150 to read text in each source 151/153 to find phrases that contain the knowledge for comparison in natural language structures that augment, corroborate or refute existing knowledge propositions 206. Some embodiments include one or more machine learning 616 algorithms using natural language analysis to scan text input from digital assets 151/153 to automatically infer causal and other relationships contained in the text based on declarative statements containing both cause and effect in transitive active (if/then) or passive (result/because) structure. Some embodiments include an inference heuristic 508 (an example of which is described above) with knowledge proposition 206 formation rules that enable creation of new well-formed knowledge propositions 206 (e.g., the knowledge propositions described above). Some embodiments include a plurality of heuristic algorithms 508 for generating concept nodes and descriptive, taxonomical, meronomical, spatial, temporal, linguistic and other named relationships, and generate new directed subgraphs 206 containing mechanistic cause and effect nodes connected by relation 203 vertices based on inferred causal and other relationships (e.g., relationships stored in the memory of the system).

Some embodiments include weighting algorithms for applying and adjusting confidence values 517 to relations between nodes and directed subgraphs 206 in the knowledge graph 121 based on frequency of validation in digital asset 151/153 search or the reliability of the source of the content. Some embodiments include qualifying heuristics 508 using nodes, wherein the qualifier 205 defines a known constraint that further defines the unique relationship 203 between the nodes in a subgraph 206. Some embodiments include machine learning 616 algorithms and heuristics 508 to associate newly acquired or inferred concepts and subgraphs 206 (e.g., the concepts and/or subgraphs stored in the memory of the system) to concepts and subgraphs 206 already present in the knowledge graph 121, then flag them for validation 606/817 prior to permanent storage.

Some embodiments include machine learning algorithms 616 and heuristics 508 to modify pre-existing stored knowledge graph 121 nodes, named relationships, subgraphs 206, their components and weights 207. Some embodiments include validation heuristics 508 (e.g., as described above in reference to FIG. 9e) for using found knowledge propositions 206 to augment, corroborate or refute solutions derived from causal reasoning processes. Said sources of information include digital assets 151/153 in the form of web pages, natural language material stored on permanent storage media such as file stores accessible to the system, or case data stored in content management systems or databases. A searching process is sometimes referred to as a digital asset 151/153 search, and some of the information searched is not of the form of published documents, according to some embodiments.

In another aspect, a computational system is provided, according to some embodiments. The computational system stores information in the form of a knowledge graph 121 describing real world facts and associations in the form of contextually tagged and weighted knowledge propositions 206, in one or more knowledge domains including causality, taxonomy, meronomy, time, space, identity, language, symbols and mathematical formulas, that is used in conjunction with natural language understanding and logical inference to accurately determine (e.g., determination accuracy close to that of a human, or human level competence) why and/or how unknown factors resulted in a known outcome, and/or what outcomes are likely given known causal factors. The knowledge propositions 206 are used as a basis of resolving ambiguity and determining the actual intent from among many possible interpretations of intent for sentences in natural language understanding.

In another aspect, a method is provided for mechanistic causal reasoning, according to some embodiments. The method includes receiving an input text from a user, the input text specified in a natural language. The method also includes building a knowledge graph 121 that represents real world facts and associations in the form of contextually tagged and weighted knowledge propositions 206, in multiple knowledge domains (e.g., causality, taxonomy, meronomy, time, space, identity, language, symbols and mathematical formulas). The method also includes resolving ambiguity and determining actual intent of the user for the input text, from a plurality of interpretations of intent for sentences in natural language understanding, using the knowledge graph 121 in conjunction with natural language understanding and logical inference. The method also includes generating a response to user, as to why and/or how unknown factors resulted in a known outcome, or what outcomes are likely given known causal factors, based on the resolved ambiguity and the actual intent of the user.

### Glossary of Terms

### Activation

The spread of positive and negative electrical potential in the brain from neuron to neuron is called activation. Positive activation is called excitation and negative activation is called inhibition. In the AKM interpreter's knowledge network activation spreads from node to node based on associative links. This activation is a means of stochastic or fuzzy recognition used in the genetic selection algorithms. Excitation corresponds to “heating up” or increasing confidence values and inhibition corresponds to “cooling down” or reducing confidence values.

### Activation Wave

This expression represents the serial flow of excitation and/or inhibition triggered by a single input in a natural or artificial neural network. Natural and artificial neural networks can exhibit directional or chaotic flow of activation. An example of directional activation flow in a natural system is the human visual cortex which has multiple layers and through which activation flows sequentially from the back to the front, then on into the correlation and interpretation centers of the brain. Consequently, the deconstruction of the image in the brain's visual center is an output of a relatively directional wave of activation flow. In other areas of the brain, electrical impulses flow in less directional and more chaotic patterns, but the level of activity triggered by an input usually subsides quickly making it possible for the brain to handle new inputs triggering new waves of activation.

Once in the correlation and interpretation centers, the flow becomes much less directional or more chaotic. Activation flows in parallel to many specialized areas of the brain. These processing centers respond by sending back activation patterns that contribute to the emergent phenomena of recognition and interpretation that go on to support all cognitive functions.

Whether directional or not, the path of any activation flow in a neural system can theoretically be traced backward from the point (neuron or node) where the flow stops to the point where it began, no matter how much it spreads or branches out in the process. The collection of all such serial paths triggered by a single input constitutes is called a wave.

The complexity of the input may be arbitrary, but the more complex the input, the more complex the wave will be, hence the more difficult to trace. The science of tracing activation waves in the brain is not yet mature enough to trace the entire path of activation flow either backward or forward from neuron to neuron for a given input. Artificial systems, however, can be traced. Mimicking human activation flow patterns is one of the key objectives of many artificial neural systems including the subject of this application.

### Bi-Directional Causal Reasoning

Unified mechanistic causal reasoning can function in both directions: Forward is to analyze internal knowledge, data and literature to extract causal factors from which to build a model to predict outcomes and reverse is to apply the model to new cases to test its ability to correctly infer causes.

### Collider

In causal paths, an outcome or mediator is a collider when it is causally influenced by two or more causal factors. The name “collider” refers to the symbology in—61—graphical models, in which arrows from more than one factor and, often unrelated to one another, lead into the same node.

### Confounder

In causal paths, a confounding factor or lurking variable is a causal factor that influences more than one outcome, possibly causing a spurious association.

### Consciousness

In humans, consciousness is an emergent cognitive phenomenon usually active whenever one or more of the senses is perceptually active. Other cognitive phenomena, such as attention, derive from consciousness and may be described as “heightened states of consciousness”. In the AKM interpreter, consciousness is a state of accepting and processing input while maintaining a broader map of the spatial, temporal, commercial and social context associated with its primary user.

### Context

Context is a snapshot of the universe from a specific point of view to a specific depth. If the viewpoint is that of an astronomer at work, it could begin at her desk and include a radius of many thousands of light years. If the viewpoint is that of an electron in an inert substance, the context would encompass a very small distance. Context includes locations in space, points in time, activities, ideas, intentions, communications, motion, change, stasis, and any describable thing closely associated with the person place or thing to which the context applies. Higher or superior levels of context may be described as domains.

### Counterfactual

A counterfactual is a proposition that states that a certain associative proposition or causal link is unlikely, thus it spreads negative or inhibitory activation.

### Disambiguation

Disambiguation is the process of resolving ambiguity, especially in words, symbols or phrases that carry multiple possible meanings (polysemy). This is necessary for accurate interpretation of input human language text or utterances. Context is needed to disambiguate polysemous input.

### Domain

Domain is named concept representing a high level of a taxonomy of context in which multiple subordinate contexts exist. “Domain” may be considered to be shorthand for “Domain of Knowledge”. There are knowledge domains that correspond to specialized processing areas in IKE, such as “time”, “space”, “causality” and “meronomy”, and knowledge domains that describe specialized areas of science or human activity such as “marine biology” and “professional sports”. All these domains combine to form a taxonomy of knowledge that supports definitions of domain characteristics which may be inherited by lower level domains and contexts.

### Doping

In a genetic algorithm, doping is the process of introducing random or quasi random variables into the equation, population or gene pool to affect the process or the output or both. In this context quasi random may mean based on a random number generator, based on random selection of targets to which to apply variables, or based on non-random variables applied in a non-random way, but in which the variables have no describable association with the core interpretive processes or the targets to which the variables are applied.

### Emergence

The term “emergent behavior” has been applied to the human brain and other complex systems whose internal behavior involves non-deterministic functionality or is so complex, or involves the interaction of so many pieces that tracing the process from beginning to end is not possible or not feasible. Because of the power of computers and their ability to track internal activity, it is not possible to produce 100% untraceable processes just as it is not possible to produce a random number generator that is actually random and not ostensibly random, thus, some emergent behavior in computers, other than in some artificial neural systems or neural networks, is trackable, and thus explainable.

In the context of the AKM interpreter, emergence is a computational behavior that mimics the inventor's understanding of the spreading activation behavior of the human brain processes used to interpret human language.

### Encoding Scheme

A way of representing something using a tightly specified symbol or token set. ASCII and EBCDIC are encoding schemes for symbol systems for alphabetic and numeric symbols. In this document, encoding scheme refers to a specific design for structuring language knowledge facts and real-world knowledge facts in the form of words and other human and machine readable symbols into conceptually relevant associations that can support automated or computerized access and processing. The English language is such an encoding scheme, but its irregularities make it difficult for use in its normal form for automated processing. Well-formed syllogisms or other logical statements with a finite set of connectors and operators are a more regular encoding scheme for knowledge of facts.

### Expectation

Expectation is a concept that is relatively foreign to computing but essential to achieving high accuracy in natural language interpretation. Expectation is an a-priori set of contextual markers that describe a world familiar to the AKM interpreter system based on the world familiar to the human user. The more the system knows about the primary users and their surroundings, the better it will be able to determine the users' intentions based on the words they submit to the system as input.

### Fitness

Fitness is a characteristic of a candidate solution or a part thereof. In a genetic selection process, survival-of-the-fittest is used to differentiate possible solutions and enable the one or more fittest solutions to emerge victorious.

### Genetic Selection

Genetic Selection is a process of survival-of-the-fittest in which fitness algorithms are applied to multiple possible solutions and only the best survive each generation. Unlike winner-take-all processes in which only the single best candidate solution emerges, genetic selection can yield multiple surviving solutions in each generation. Then, as successive generations are processed, survivors from previous generations may die off if the succeeding generations are more fit.

### Inference

Inference involves correlating multiple constraints contained in input and derived from other sources as premises, and drawing conclusions based on testing the relative truth of multiple propositions affecting each constraint or premise.

Inference is what humans constantly do with their brains. Based on perceptions, humans make inferences about meaning, about the state of things, about consequences of actions, and about life, the universe, and everything. Inference involves applying logic to new information derived from senses and remembered information stored in the brain to form conclusions.

Forming conclusions is important because the conclusions form a basis for correct interpretation and appropriate further processing. The AKM interpreter is capable of abandoning an inferred conclusion if newer information prompts it to do so.

### Knowledge

The term knowledge means correlated information. This definition is part of a larger continuum in which everything interpretable can be assigned to some point on the continuum. The position of knowledge in this continuum can be described in terms of its complexity relative to other things in the environment that are interpretable. The level of facts that humans can learn and describe in simple phrases is called existential knowledge.

Existential knowledge is the kind of knowledge expressed in almanacs. At the complex end of the knowledge continuum is one or more levels of meta-knowledge or knowledge about knowledge.

The term “noise” is borrowed from radio wave theory to describe environmental things that interfere with the interpretation of or acquisition of knowledge. Noise, the simplest of all interpretable things, is made up of things in the perceptual environment or input that are less meaningful than data and typically irrelevant to the process or solution under consideration. An interpretation system must be able to process noise because it is omnipresent. Thus, a system must have knowledge that enables it to differentiate noise from salient data, though this may be more of an attention function than actual knowledge. Once the noise in the environment is filtered out, all that remains is data, which can be correlated to constitute information and knowledge.

Data elements that humans process are input in the form of perceptual stimuli to the five senses. The specific types of data available are tactile sensations, tastes, smells, sounds and images. These perceptual inputs are processed in specialized areas of the brain, correlated in parallel, then used as the basis for cognitive processing. The AKM interpreter algorithms are primarily designed to interpret human language, but are also able to be generalized to interpret the other forms of sensory input described above.

### Knowledge Base

The AKM interpreter uses a combination of a lexicon and a Knowledge Network that contain information about things in the world and the way they are interrelated, and a meta-knowledge catalog describing the contents of digital assets 151/153.

### Knowledge Network

A massively interconnected network of information about how linguistic and real-world objects relate to one another.

### Lexicon

Lexicon is a list of words, letters, numbers and phrases used in a natural language, such as English, that express meaning or facts or represent objects or phenomena. The lexicon consists of a list of lexical items, each a word or symbol or combination thereof. In the AKM interpreter, the lexicon is a gateway to the knowledge network.

### Mutation

In a genetic algorithm mutation is a process of altering, possibly randomly, the characteristics of a candidate solution or a part thereof during processing. The mutated result then can compete with other results for fitness as a solution.

### Natural Language Processing

Natural language processing means using computers to analyze natural language input, such as English sentences, for the purpose of interpretation, paraphrasing or translation.

### Neural

Of, resembling or having to do with the processing components and functions of the brain and/or its cells. Perceptual, inquisitive, communicative, interpretive, creative and decisive cognitive processes occur in the brain through the functioning of its network of neuron cells. Those processes are neural and automated processes designed to resemble the structure and/or functions of these processes are often characterized as neural.

### Polysemy

The linguistic phenomenon of multiple meanings applying to a single word, symbol or phrase.

### Real-World Knowledge

Facts about phenomena and objects. In this document, real-world knowledge refers to information or data associations encoded in an ontology or knowledge graph in a meaningful or expressive way to represent facts in the world. Some facts describe the hierarchical relations between classes and subclasses of objects in the real world such as “a dog is Canine in the animal kingdom”. Other facts describe causal relations such as “gravity pulls physical objects toward itself”, and yet others describe constructive relations such as “a knob is part of a door”.

### Stochastic

Non-deterministic or “fuzzy” processing techniques and encoding approaches that deliver output from a process that uses statistical probabilities instead of simple true false logic. In some stochastic processes it is virtually impossible to predict the output based on the inputs because of the sheer number of permutations and/or the complexity of the weighting mechanisms and processes to adjust weights during the course of the process and prior to the output.

### Token

A token is a discrete string of one or more symbols or characters that has a beginning and an end and an unchanging content. If the content were to change through the addition, subtraction or modification of one or more of its characters, it would become a different token.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A system comprising: one or more permanent information storage units, one or more memory units each operable to store at least one program; and at least one processor communicatively coupled to the one or more memory units, in which the at least one program, when executed by the at least one processor, causes the at least one processor to:
scan and read public and private digital materials to understand the meaning of each part of said materials for the purpose of cataloging their contents as meta-knowledge and identifying concepts in contexts previously unknown to said system for the purpose of incrementally adding said unknown concepts as fully formed knowledge propositions;
receive input data from a user describing a request or a case and known background information about the case, wherein the case is a set of causes and/or outcomes, wherein the information about the case lacks sufficient information about why a known outcome occurred or what outcome will occur as a result of known causal factors;
determine whether the user intends to generate a predicted outcome from known causes or infer predicted causes from a known outcome, wherein forward reasoning that maps known causes to inferred outcomes, or reverse reasoning that maps known outcomes to inferred causal factors, are based on a knowledge graph with subgraphs retained in one or more permanent information storage units, wherein at least one subgraph is linked to another subgraph, each of the subgraphs representing a knowledge proposition including: a subject component, an associate component, a named relationship component that links the subject component and the associate component, a context component that identifies a domain of knowledge that an association is true, a qualifier component that describes a constraint governing the relationship that further narrows the context in which the association is true, or points to a specialized linked list storing a causal path;
a weight component that is a probability factor or a likelihood that the proposition that the subject component is related to the associate component in the context identified by the context component, and a mechanism component that describes an action that the subject component is performing to affect the associate component is generally applicable or logically true;
traverse the knowledge graph, including: associate each word of the input with a lexicon object and associate each lexicon object with a plurality of propositions in the knowledge graph, wherein each proposition corresponds to a subgraph, wherein propositions define a relationship between the subject component and the associate component in a defined context in the subgraph;
classify the input and associated knowledge propositions into named attributes of named specialized processing areas based on named relationships in propositions, wherein each specialized processing area represents a contextual component of a solution, wherein each attribute in each specialized processing area represents a characteristic associated with a concept defining a respective specialized processing area, wherein a candidate is a potential component or related person, place, thing or concept of an unknown outcome and/or unknown cause associated with the named attribute, wherein each candidate is associated with a modifiable confidence vector including a weight component and an emergence flag, wherein processing in a specialized processing area includes:
activating emergent behavior by modifying the weight component of each confidence vector of each candidate, wherein a starting value of the weight component is based on the knowledge proposition weight stored in the knowledge graph, wherein value of the weight component is increased each time a corroborating knowledge proposition is processed, and wherein the value of the weight component is decreased each time a refuting knowledge proposition is processed, and
modifying a candidate confidence vector of each candidate in each specialized processing area based on frequency of matching between a respective candidate and at least one of: (i) a respective user input, doping input and priming input, and (ii) knowledge propositions encoded in at least one subgraph, to bring about emergent behavior by incrementing or decrementing a weighting component of the candidate confidence vector;
extract emergent candidates from each attribute of each specialized processing area with a largest value of the weighting component of the candidate confidence vector; and
invoke a specialized ordered linked list representing a causal path wherein each node contains the next sequential causal factor in leading to a specified outcome; and
each causal path node contains a pointer to exactly one knowledge propositions in a knowledge graph and a pointer to the next causal factor node in the causal path; and
in which the sequence of the nodes corresponds to sequence in a causal path beginning with a root cause and terminating in an outcome; and
infer a solution of unknown outcome and/or unknown causes based on emergent candidates for each attribute of the specialized processing areas.

2. The system of claim 1, further comprising:
a storage architecture configured to include temporary special processing area structures used to classify and organize the input data from a user by named category, including:
a plurality of context dimensions as ordered multi-dimensional storage structures, including: a named context header, one or more attribute dimensions, each attribute dimension representing a subject component, each attribute dimension being associated with a respective candidate dimension, wherein one or more attribute dimensions is associated with a respective context dimension, each attribute dimension containing a name representing a specific concept applicable to the named context header of said associated context dimension; wherein at least one candidate dimension contains zero or more knowledge propositions, for each named attribute object in said attribute dimension.

3. The system of claim 2, wherein at least one multi-dimensional structure is specialized in causality, when more than one causal candidate exists in an attribute, said causal candidates are weighted and ordered high to low to favor the most probable causal path containing causal factors that have the highest probability of solving the input case;
wherein in any given multi-dimensional structure specialized in taxonomy, when more than one candidate exists in an attribute, said candidates are ordered to represent a hierarchical or taxonomical ordering scheme of super-ordinate and subordinate classes of objects;
wherein in any given multi-dimensional structure specialized in space and time, when more than one candidate exists in an attribute, said candidates are ordered to represent a spatial or temporal ordering scheme of location and time classes of objects;
wherein in any given multi-dimensional structure specialized in meronomy, when more than one candidate exists in an attribute, said candidates are ordered to represent a part-whole constructive ordering scheme of part and whole classes of objects;
wherein each attribute dimension is defined as either required or optional for solution generation;
wherein each said candidate is associated with a vector comprised of magnitude and direction components, constituting an adjustable score for each said candidate; and
wherein candidate object related information further includes an original magnitude and emergence flag for each candidate.

4. The system of claim 3, wherein the at least one program further includes instructions for analysis of meaning of an ordered group of input text objects forming natural language phrases and sentences based on a scoring strategy, the instructions comprising:
segregating individual words in the input text, adding them to a word list in short-term memory (STM) and searching for each input word in a lexicon having a plurality of words therein, each said word linked to a plurality of knowledge propositions;
analyzing morphology of said words by determining if a prefix or suffix has been added to a root word to form said input words, and adding root words to the word list;
extracting, from the knowledge graph, said knowledge propositions formed, in part, by each word in the word list;
classifying a plurality of candidates formed of directed subgraphs, each said candidate describing an explicit logical relationship between one object and another object, into a plurality of specialized processing areas;
comparing a first or X object of each candidate to find matching objects in STM and adjusting the vector of each candidate based on the quantity of matching objects;
comparing a second or Y object of each candidate to find matching objects in STM and adjusting the vector of each candidate based on the quantity of matching objects;
comparing a third or C object of each candidate to find matching objects in STM and adjusting the vector of each candidate based on the quantity of matching objects;
invoking and executing interpretation heuristics associated with the named relationship or R values of the candidates with the highest score vectors to further reorder concepts in each attribute dimension of each specialized processing area based on fitness;
adjusting the score vector assigned to affected candidates based on a quantity of recurring objects or a frequency of encountering recurring objects during heuristic processes;
reordering said candidates in descending order based on the direction and magnitude of said vectors, wherein said vector directions comprise emerging, static, and falling conditions;
wherein said vector magnitudes comprise numeric values, when compared with a numeric threshold value, are determined to be above threshold, at threshold, or below threshold value;
determining the context of the of the input text based on the highest scored C object in the appropriate specialized processing areas; invoking and executing additional heuristics to find candidates for any required attributes with no candidates, and if found, repeating the process of segregating, analyzing, extracting, classifying, comparing, invoking, adjusting, reordering, determining, invoking and executing additional heuristics steps;
applying a fitness algorithm to determine the fittest candidates of those compared in each attribute dimension of each specialized processing area; and
formulating a meaning profile based on the highest scoring or fittest emergent candidate of each attribute dimension of each specialized processing area.

5. The system of claim 3, wherein the at least one program further includes instructions for performing deep natural language understanding, the instructions comprising:
receiving input text, formed of a plurality of words, and matching each word with a word in the lexicon to populate an ordered word list; extracting phrases including idioms in the lexicon in which one or more words in the input appear in the phrase, and adding such phrases to said word list; using punctuation and other linguistic cues to segregate each sentence in the input to store each input sentence into an ordered sentence matrix;
extracting, from the knowledge graph, propositions formed, in part, by each word in the word list;
classifying said extracted propositions in the specialized processing areas based on an applicable attribute of a respective specialized processing area;
applying the fitness algorithms to determine the fittest propositions of those compared; and
invoking natural language understanding heuristics to interpret the context and relationships of said words, phrases and sentences by analyzing each level of linguistic content of said data objects, wherein the levels include pragmatics or context, semantics, grammar or syntax, morphology, phonology, and prosody.

6. The system of claim 1, wherein the at least one program further includes instructions for analysis of the causality based on a scoring strategy of an ordered group of input text objects forming natural language words and phrases classified into a specialized processing area for causality fitness processing representing causal factors or outcomes, the instructions comprising:
providing a plurality of candidates formed of directed subgraphs, each said candidate describing an explicit causal relationship between one object and another object;
comparing a first or X object of each candidate to find matching objects in STM and adjusting the vector of each candidate based on the quantity of matching objects;
comparing a second or Y object of each candidate to find matching objects in STM and adjusting the vector of each candidate based on the quantity of matching objects;
comparing a third or C object of each candidate to find matching objects in STM and adjusting the vector of each candidate based on the quantity of matching objects;
invoking and executing causality heuristics associated with the named relationship or R values of the candidates with the highest score vectors to further reorder concepts in the attributes dimension of each specialized processing area;
adjusting the score vector assigned to affected candidates based on the quantity of common objects or the frequency of encountering common objects during heuristic processes;
reordering said candidates based on the direction and magnitude of said vectors, wherein said vector directions comprise emerging, static, and falling conditions;
wherein said vector magnitudes comprise numeric values, when compared with a numeric threshold value, are determined to be above threshold or emergent, at threshold, or below threshold value;
determining the context of the of the input text based on the highest scored or fittest emergent C object in the appropriate specialized processing areas;
invoking and executing additional heuristics to find candidates for any required attributes with no candidates, and if found, repeating the providing, comparing the first or X object, comparing the second or Y object, comparing the third or C object, invoking and
executing, adjusting the score vector, reordering, determining the context, and invoking and executing the additional heuristics; and
invoking and executing causality heuristics to create contiguous causal chains or paths that identify and order the most likely causal factors and outcomes for the input data set.

7. The system of claim 6, further comprising means for generating, filtering and scoring alternative candidates for solutions including,
forward-looking solutions selecting and prioritizing predicted outcomes for known causal factors;
reverse solutions selecting and prioritizing likely candidate causal factors for known outcomes;
heuristic algorithms for applying forward-chaining inference rules to adjust the prioritization of solution candidates;
heuristic algorithms for applying backward-chaining inference rules to find candidates in the input or the knowledge network for required attribute dimensions with no candidates;
rules within the heuristic algorithms for differentiating binary and non-binary factors and applying weighting to each candidate to show both the likelihood of the candidate of forming part of a final solution and the degree to which emergent candidates participate in the outcome;
inheritance rules within the heuristic algorithms for applying characteristics of higher-ordered taxonomical concepts to lower-ordered taxonomical concepts; and
a human user interface to display prioritized solutions, their weightings and explanations.

8. The system of claim 7, further comprising a lineage tracking algorithm for generating explanations based on the rules and causal path that lead to the solution, and why other possible solutions were rejected, and
also comprising a source reference system providing the name and location of the one or more digital assets that contain the knowledge from which the solution was derived.

9. The system of claim 7, further comprising means of automatically validating a solution by searching literature with an advanced causal natural language interpreter to find and analyze corroborating text stating that said solution is possible, common, unlikely or impossible, including,
searching and analyzing text in web pages on the open web;
searching and analyzing text in deep web content sources with limited access controlled by membership; and
searching and analyzing text in case data in internal systems, documents and databases.

10. The system of claim 1, wherein the at least one program further includes instructions for searching a plurality of named sources for information to be used in the creation of new knowledge propositions to build a knowledge graph for use in causal reasoning and natural language understanding, and in the validation of inferred knowledge propositions and solutions, further comprising:
a knowledge graph comprising a plurality of predefined seed concept nodes connected by descriptive, taxonomical, meronomical, spatial, temporal, linguistic and other named relationship vertices, and a plurality of directed subgraphs containing manually defined mechanistic cause and effect nodes connected by relation vertices;
a search string formulator algorithm and user interface to search a plurality of named sources for content matching the search string or logical components thereof;
a source list manager and user interface for selecting sources to search to support learning and validation;
a search bot to read text in each source to find phrases that contain the knowledge for comparison in natural language structures that augment, corroborate or refute existing knowledge propositions;
machine learning algorithms using natural language analysis to scan text input from digital assets to automatically infer causal and other relationships contained in the text based on declarative statements containing both cause and effect in transitive active (if/then) or passive (result/because) structure; an inference heuristic with knowledge proposition formation rules that enable creation of new well-formed knowledge propositions of the structure;
a plurality of heuristic algorithms for generating concept nodes and descriptive, taxonomical, meronomical, spatial, temporal, linguistic and other named relationships, and generate new directed subgraphs containing mechanistic cause and effect nodes connected by relation vertices based on previously inferred causal and other relationships;
weighting algorithms for applying and adjusting confidence values to relations between nodes and directed subgraphs in the knowledge graph based on frequency of validation in literature search;
qualifying heuristics using nodes, wherein the qualifier defines a known constraint that further defines the unique relationship between the nodes in a subgraph;
machine learning algorithms and heuristics to associate newly acquired or inferred concepts and subgraphs to concepts and subgraphs already present in the knowledge graph, then flag them for validation prior to permanent storage;
machine learning algorithms and heuristics to modify pre-existing stored knowledge graph nodes, named relationships, subgraphs, their components and weights;
validation heuristics for using found knowledge propositions to augment, corroborate or refute solutions derived from causal reasoning processes; and
wherein said sources of information include web pages, documents, spreadsheets, presentation slide decks, audio files, video files and other natural language material stored on permanent storage media such as file stores accessible to the system, or case data stored in content management systems or databases.

11. The system of claim 1, wherein processing in the specialized processing area further includes:
retrieving doping inputs and priming inputs from a context associated heuristic algorithm that generates respective doping inputs and priming inputs for the input, and apply the respective doping inputs and priming inputs to each candidate in each attribute in each specialized processing area.

12. The system of claim 1, wherein the at least one program further includes instructions for:
detecting gaps by determining whether any attribute of any specialized processing area is required for a solution that has no candidates and in response to determining that a respective attribute has no candidates, performing further search of the knowledge graph for possible candidates.

13. A method comprising: receiving input data from a user, the input data describing a request or case and known background information about the case, wherein the case is a set of causes and/or outcomes,
wherein the information about the request or case lacks sufficient information about why a known outcome occurred or what outcome will occur as a result of known causal factors;
determining whether the user intends to answer a question, perform a task or generate a predicted outcome from known causes or generate predicted causes from a known outcome, wherein forward reasoning that maps known causes to inferred outcomes, or reverse reasoning that maps known outcomes to inferred causal factors, are based on a knowledge graph with subgraphs, wherein at least one subgraph is linked to another subgraph, each of the subgraphs representing a knowledge proposition including: a subject component, an associate component, a named relationship component that links the subject component and the associate component, a context component that identifies a domain of knowledge that an association is true, a qualifier component that describes a constraint governing the relationship that further narrows the context in which the association is true,
a weight component that is a probability factor of a likelihood that the proposition that the subject component is related to the associate component in the context identified by the context component, and a mechanism component that describes an action that the subject component is performing to affect the associate component;
traversing the knowledge graph, including: associating each word of the input with a lexicon object and associate each lexicon object with a plurality of propositions in the knowledge graph, wherein each proposition corresponds to a subgraph, wherein propositions define a relationship between the subject component and the associate component in the subgraph;
traversing specialized linked lists or other structured knowledge related to a lexicon object providing sequential or episodic knowledge composed of a plurality of subgraphs in which the sequence is essential to full understanding;
classifying the input and associated knowledge propositions into named attributes of named specialized processing areas based on named relationships in propositions, wherein each specialized processing area represents a contextual component of a solution, wherein each attribute in each specialized processing area represents a characteristic associated with a concept defining a respective specialized processing area, wherein a candidate is a potential component of an unknown outcome and/or unknown cause associated with the named attribute, wherein each candidate is associated with a modifiable confidence vector including a weight component and an emergence flag, wherein processing by a specialized processing area includes:
activating emergent behavior by modifying the weight component of each confidence vector of each candidate, wherein a starting value of the weight component is based on the knowledge proposition weight stored in the knowledge graph, wherein value of the weight component is increased each time a corroborating knowledge proposition is processed, and wherein the value of the weight component is decreased each time a refuting knowledge proposition is processed, and
modifying a candidate confidence vector of each candidate in each specialized processing area based on frequency of matching between a respective candidate and at least one of: (i) a respective user input, doping input and priming input, and (ii) knowledge propositions encoded in at least one subgraph, to bring about emergent behavior by incrementing or decrementing a weighting component of the candidate confidence vector;
extracting emergent candidates from each specialized processing area with a largest value of the weighting component of the candidate confidence vector; and generating a solution including unknown outcome and/or unknown causes based on emergent candidates for each attribute of the specialized processing areas.

14. A non-transitory computer readable storage medium, wherein the non-transitory computer readable storage medium stores instructions, which when executed by a computer system, cause the computer system to perform a method comprising:
receiving input data from a user, the input data describing a request or a case and known background information about the case, wherein the case is a set of causes and/or outcomes, wherein the information about the case lacks sufficient information about why a known outcome occurred or what outcome will occur as a result of known causal factors;
determining whether the user intends to generate a predicted outcome from known causes or generate predicted causes from a known outcome, wherein forward reasoning that maps known causes to inferred outcomes, or reverse reasoning that maps known outcomes to inferred causal factors, are based on a knowledge graph with subgraphs, wherein at least one subgraph is linked to another subgraph, each of the subgraphs representing a knowledge proposition including:
a subject component, an associate component, a named relationship component that links the subject component and the associate component, a context component that identifies a domain of knowledge that an association is true, a qualifier component that describes a constraint governing the relationship that further narrows the context in which the association is true,
a weight component that is a probability factor of a likelihood that the proposition that the subject component is related to the associate component in the context identified by the context component, and a mechanism component that describes an action that the subject component is performing to affect the associate component;
traversing the knowledge graph, including: associating each word of the input with a lexicon object and associate each lexicon object with a plurality of propositions in the knowledge graph, wherein each proposition corresponds to a subgraph, wherein propositions define a relationship between the subject component and the associate component in the subgraph;
classifying the input and associated knowledge propositions into named attributes of named specialized processing areas based on named relationships in propositions, wherein each specialized processing area represents a contextual component of a solution, wherein each attribute in each specialized processing area represents a characteristic associated with a concept defining a respective specialized processing area, wherein a candidate is a potential component of an unknown outcome and/or unknown cause associated with the named attribute, wherein each candidate is associated with a modifiable confidence vector including a weight component and an emergence flag, wherein processing by a specialized processing area includes:
activating emergent behavior by modifying the weight component of each confidence vector of each candidate, wherein a starting value of the weight component is based on the knowledge proposition weight stored in the knowledge graph, wherein value of the weight component is increased each time a corroborating knowledge proposition is processed, and wherein the value of the weight component is decreased each time a refuting knowledge proposition is processed, and
modifying a candidate confidence vector of each candidate in each specialized processing area based on frequency of matching between a respective candidate and at least one of: (i) a respective user input, doping input and priming input, and (ii) knowledge propositions encoded in at least one subgraph, to bring about emergent behavior by incrementing or decrementing a weighting component of the candidate confidence vector;
extracting emergent candidates from each specialized processing area with a largest value of the weighting component of the candidate confidence vector; and generating a solution of unknown outcome and/or unknown causes based on emergent candidates for each attribute of the specialized processing areas.

15. A method for mechanistic causal reasoning, comprising:
receiving an input text from a user, the input text specified in a natural language; building a knowledge graph that represents real world facts and associations in the form of contextually tagged and weighted knowledge propositions, in multiple knowledge domains including causality, taxonomy, meronomy, time, space, identity, language, symbols and mathematical formulas; and
resolving ambiguity and determining actual intent of the user for the input text, from a plurality of interpretations of intent for sentences in natural language understanding, using the knowledge graph in conjunction with natural language understanding and logical inference; and
generating a response for the user, as to why and/or how unknown factors resulted in a known outcome, or what outcomes are likely given known causal factors, based on resolving the ambiguity and determination of the actual intent.

16. A non-transitory computer readable storage medium, wherein the non-transitory computer readable storage medium stores instructions, which when executed by a computer system, cause the computer system to perform a method comprising:
receiving an input text from a user, the input text specified in a natural language; building a knowledge graph that represents real world facts and associations in the form of contextually tagged and weighted knowledge propositions, in multiple knowledge domains including causality, taxonomy, meronomy, time, space, identity, language, symbols and mathematical formulas; and
resolving ambiguity and determining actual intent of the user for the input text, from a plurality of interpretations of intent for sentences in natural language understanding, using the knowledge graph in conjunction with natural language understanding and logical inference; and
generating a response for the user, as to why and/or how unknown factors resulted in a known outcome, or what outcomes are likely given known causal factors, based on resolving the ambiguity and determination of the actual intent.

17. A system comprising:
one or more memory units each operable to store at least one program; and at least one processor communicatively coupled to the one or more memory units, in which the at least one program, when executed by the at least one processor, causes the at least one processor to:
receive an input text from a user, the input text specified in a natural language; build a knowledge graph that represents real world facts and associations in the form of contextually tagged and weighted knowledge propositions, in multiple knowledge domains including causality, taxonomy, meronomy, time, space, identity, language, symbols and mathematical formulas; and
resolve ambiguity and determining actual intent of the user for the input text, from a plurality of interpretations of intent for sentences in natural language understanding, using the knowledge graph in conjunction with natural language understanding and logical inference; and
generate a response for the user, as to why and/or how unknown factors resulted in a known outcome, or what outcomes are likely given known causal factors, based on resolving the ambiguity and determination of the actual intent.
